(19) United States
(12) Patent Application Publication
(10) Pub. No.: US 2015/0242862 A1
(43) Pub. Date: Aug. 27, 2015

(54) LICENSE AND CERTIFICATION COMPLIANCE MANAGEMENT SYSTEM AND METHOD

(71) Applicants: Grace Lacinda Rupple, Flower Mound, TX (US); Nancy Evans, Wichita Falls, TX (US)

(72) Inventors: Grace Lacinda Rupple, Flower Mound, TX (US); Nancy Evans, Wichita Falls, TX (US)

(21) Appl. No.: 14/630,222

(22) Filed: Feb. 24, 2015

Related U.S. Application Data
(60) Provisional application No. 61/944,267, filed on Feb. 25, 2014.

(51) Int. Cl. G06Q 30/00

(52) U.S. Cl. CPC G06Q 30/018

(57) ABSTRACT

A license and certification management platform includes a client device and a server that stores information related to one or more licenses or credentials and a requirement corresponding with the one or more licenses or credentials. The server determines a critical date associated with the requirement and when a current date is within a threshold period of time from the critical date. The server informs the client device regarding the requirement and critical date in a notification message that includes an alert configured to inform the user regarding an action to be taken by the user. The client computing device displays the information related to one or more licenses or credentials and at least one requirement corresponding to the one or more licenses or credentials. The client includes a transmitter configured transmit at least a portion of the user compliance information back to the server.

### CROSS-REFERENCE TO RELATED APPLICATION(S) AND CLAIM OF PRIORITY

The present application claims priority to U.S. Provisional Patent Application Ser. No. 61/944,267, filed Feb. 25, 2014 entitled “LICENSE AND CERTIFICATION COMPLIANCE MANAGEMENT METHOD.” The content of the above-identified patent document is incorporated herein by reference.

### TECHNICAL FIELD

The present application relates generally to professional certifications and licensing, and more particularly to a system and method for managing professional certifications and licenses.

### BACKGROUND

Many professionals who are engaged in providing services to the public are often required to obtain certifications and be either registered to practice in a specific jurisdiction or licensed to practice in a specific area. These professionals include medical doctors, lawyers, engineers, nurses, dentists, pharmacists, medical technicians, architects, emergency personnel, such as first responders, and so forth. Often, these professionals obtain a number of certifications or are registered, or licensed, in a number of areas or a number of jurisdictions.

### SUMMARY

In a first embodiment, a server is provided. The server includes a storage device configured to store information related to one or more licenses or credentials. The server also includes an interface configured to receive a requirement corresponding with the one or more licenses or credentials. The server further includes processing circuitry configured to: store the requirement with the information related to the one or more licenses or credentials, analyze the information related to one or more licenses or credentials and determine a critical date associated with the requirement, determine whether a current date is within a first threshold period of time from the critical date, and in response to determining that the current date is within the first threshold period of time, transmit, via the interface, a notification message to a client device, the notification message comprising an alert configured to provide information regarding an action to be taken.

In a second embodiment, a method is provided. The method includes receiving, by a server, information related to one or more licenses or credentials. The method also includes storing, by the server, the information related to one or more licenses in a storage device. The method further includes identifying, by the server, at least one requirement corresponding with the one or more licenses or credentials. Further, the method includes generating display data configured to be displayed on a client device, the display data comprising summary information comprising at least one of: a summary of credentials with past due or upcoming expiration dates, a number of continuing education hours required to meet a renewal requirement, a listing of planned continuing education courses, an address of the compliance authority, an address of at least one provider of continuing education courses, and an address of at least one insurance provider.

In a third embodiment, a client computing device is provided. The client computing device includes a display configured to display information related to one or more licenses or credentials and at least one requirement corresponding to the one or more licenses or credentials. The client computing device also includes processing circuitry configured to receive user compliance information to be associated with the one or more licenses or credentials. The client computing device further includes a transmitter configured transmit at least a portion of the user compliance information to a remote server.

In a fourth embodiment, a plurality of instructions stored on a non-transitory computer readable medium is provided. The plurality of instructions configured to, when executed by a processor, cause the processor to generate display information related to one or more licenses or credentials and at least one requirement corresponding to the one or more licenses or credentials; receive user compliance information to be associated with the one or more licenses or credentials; and transmit at least a portion of the user compliance information to a remote server.

Other technical features may be readily apparent to one skilled in the art from the following figures, descriptions, and claims. Definitions for other certain words and phrases are provided throughout this patent document. Those of ordinary skill in the art should understand that in many if not most instances, such definitions apply to prior as well as future uses of such defined words and phrases.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example computing system according to embodiments of the present disclosure;

FIG. 2 illustrates example server device in a computing system according to embodiments of the present disclosure;

FIG. 3 illustrates example client device in a computing system according to embodiments of the present disclosure

FIG. 4 illustrates a license and certification compliance management platform according to embodiments of the present disclosure;

FIG. 5 illustrates a license and certification compliance management network according to embodiments of the present disclosure;

FIG. 6 illustrates an initial page (landing page) displayed by client device according to embodiments of the present disclosure;

FIG. 7 illustrates a Registration Page displayed by client device according to embodiments of the present disclosure;

FIG. 8 illustrates a Payment Page displayed by client device according to embodiments of the present disclosure;

FIG. 9 illustrates a Login Page displayed by client device according to embodiments of the present disclosure;

FIG. 10 illustrates a Dashboard Page displayed by client device according to embodiments of the present disclosure;

FIG. 11 illustrates an Account Page displayed by client device according to embodiments of the present disclosure;

FIG. 12 illustrates a Practitioner Page displayed by client device according to embodiments of the present disclosure;

FIG. 13 illustrates a Library of Past Credentials view displayed by client device according to embodiments of the present disclosure;

FIG. 14 illustrates a Credential Report according to embodiments of the present disclosure;

FIG. 15 illustrates a Practice Page displayed by client device according to embodiments of the present disclosure;

FIG. 16 illustrates a Library of Past Credentials view for a Practice displayed by client device according to embodiments of the present disclosure;

FIG. 17 illustrates a process for managing credential requirements according to embodiments of the present disclosure;

FIG. 18 illustrates a process for managing credential requirements on a client device according to embodiments of the present disclosure;

FIG. 19 illustrates a process for managing insurance requirements on a client device according to embodiments of the present disclosure;

FIG. 20 illustrates a process for managing credential requirements for a business or practice according to embodiments of the present disclosure; and

FIG. 21 illustrates a process for managing credential requirements for a business or practice on a client device according to embodiments of the present disclosure.

### DETAILED DESCRIPTION

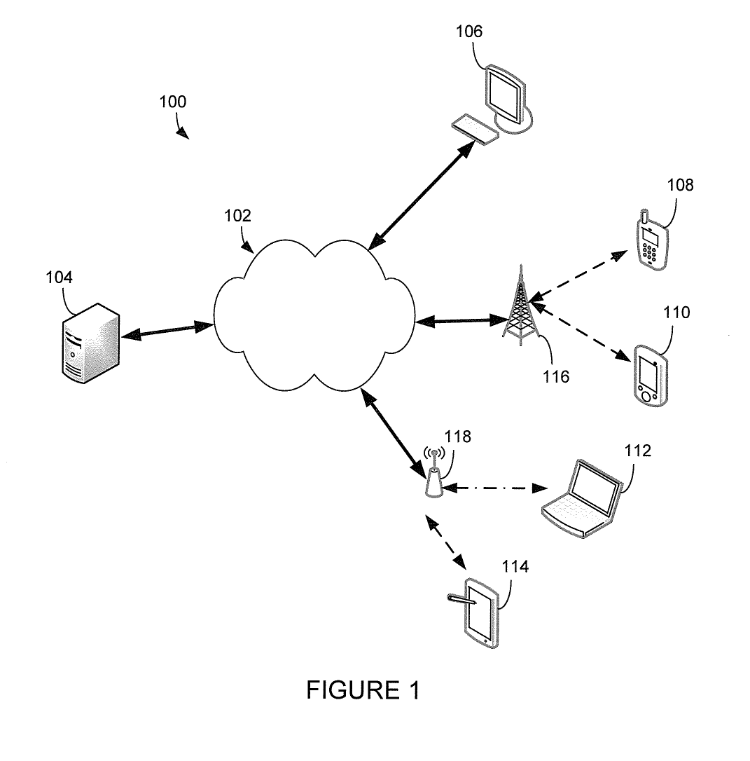

FIGS. 1 through 21, discussed below, and the various embodiments used to describe the principles of the present invention in this patent document are by way of illustration only and should not be construed in any way to limit the scope of the disclosure. Those skilled in the art will understand that the principles of this disclosure may be implemented in any suitably arranged device or system.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

A professional service provider (“practitioner”) includes those who have first obtained a Professional Degree, such as medical doctors, lawyers, engineers, nurses, dentists, pharmacists, optometrists, ophthalmologists, architects, psychiatrists, psychologists, accountants, veterinarians, chiropractors, and so forth. A practitioner also includes medical technicians, dental technicians emergency personnel, such as first responders, professional services staff, and so forth. As providers of services related to the welfare of the general public, these practitioners often are required to obtain certifications, registrations, permits, or licenses, or a combination of thereof, to ensure a standard of service for their respective professions as well as provide a level of care and safety to the general public whom they serve. Herein, register refers to the recording of an individual as a qualified professional on a specified list such as a registry; license refers to a permission granted by a competent authority to engaged in a specified business or occupation; and certification refers to a recognition by a competent authority that the professional has met and maintains special qualifications within a field of study or service. Examples of Licenses include: admission to a State Bar, License to Practice Medicine, License to Practice Dentistry, License to Practice Veterinary Medicine, Professional Engineer (PE), Registered Architect (RA), Certified Public Accountant (CPA), Registered Nurse (RN), Chiropractor, Teacher, and the like. The competent authorities include state government agencies, federal government agencies, state professional boards, and the like. To obtain the aforementioned certifications and licenses, and often times in order to register, the practitioner is often required to complete extensive coursework, obtain a professional degree, and pass one or more competency exams. The exams may be written, oral, practical or a combination thereof. After obtaining the certifications or licenses, or when registered, the practitioner typically is further required to one or more of: 1) re-register on a temporal basis, such as annually; 2) complete continuing education courses within the specified field of service; and 3) maintain professional liability insurance. Furthermore, businesses that employ the practitioner or provide the professional services to the public also are required to maintain records of the practitioner's compliance with the certifications, licensing, and continuing education as well as maintain respective liability and workers compensation insurance policies.

Therefore, practitioners, such as Business and Medical, Dental, legal and Engineering service professionals have the mandatory obligation to maintain multiple credentials that are valid for finite periods of time. The certifying entities do not proactively notify the practitioners regarding registration dates, continuing education dates or changes in compliance requirements since it is commonly accepted that it is the practitioner's responsibility to maintain and manage their own certifications. Significant risk exists to the practitioners if a credential or registration lapses.

Accordingly, embodiments of the present disclosure enable the practitioner to effectively and efficiently manage license and certification compliance. Embodiments of the present disclosure also enable a business manager or supervisor to effectively and efficiently manage license and certification compliance for multiple practitioners employed by, or contracted with, the business.

In certain embodiments of the present disclosure, a License and Certification Compliance Management Platform (LCMP) utilizes a web infrastructure to provide an integrated and active portal that enables professional services business, such as hospitals, doctors offices, engineering firms and the like, and professional services practitioners to enter compliance information into one or more servers to maintain and manage various elements of the compliance information. In certain embodiments, the professional services business and practitioners can enter additional expiration or renewal information. In certain embodiments, the professional services business and practitioners can upload proof of certification documents received from compliance oversight entities.

FIG. 1 illustrates an example computing system 100 according to this disclosure. The embodiment of the computing system 100 shown in FIG. 1 is for illustration only. Other embodiments of the computing system 100 could be used without departing from the scope of this disclosure.

The system 100 includes a network 102, which facilitates communication between various components in the system 100. For example, the network 102 may communicate Internet Protocol (IP) packets, frame relay frames, Asynchronous Transfer Mode (ATM) cells, or other information between network addresses. The network 102 may include one or more local area networks (LANs), metropolitan area networks (MANs), wide area networks (WANs), all or a portion of a global network such as the Internet, or any other communication system or systems at one or more locations.

The network 102 facilitates communications between at least one server 104 and various client devices 106-114. Each server 104 includes any suitable computing or processing device that can provide computing services for one or more client devices. Each server 104 could, for example, include one or more processing devices, one or more memories storing instructions and data, and one or more network interfaces facilitating communication over the network 102.

Each client device 106-114 represents any suitable computing or processing device that interacts with at least one server or other computing device(s) over the network 102. In this example, the client devices 106-114 include a desktop computer 106, a mobile telephone or smartphone 108, a personal digital assistant (PDA) 110, a laptop computer 112, and a tablet computer 114. However, any other or additional client devices could be used in the computing system 100.

In this example, some client devices 108-114 communicate indirectly with the network 102. For example, the client devices 108-110 communicate via one or more base stations 116, such as cellular base stations or eNodeBs. Also, the client devices 112-114 communicate via one or more wireless access points 118, such as IEEE 802.11 wireless access points. Note that these are for illustration only and that each client device could communicate directly with the network 102 or indirectly with the network 102 via any suitable intermediate device(s) or network(s).

As described in more detail below, the network 102 supports management of professional certifications and license compliance. The network 102 supports communication of compliance information between server 104 and one or more client devices 106-114.

Although FIG. 1 illustrates one example of a computing system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

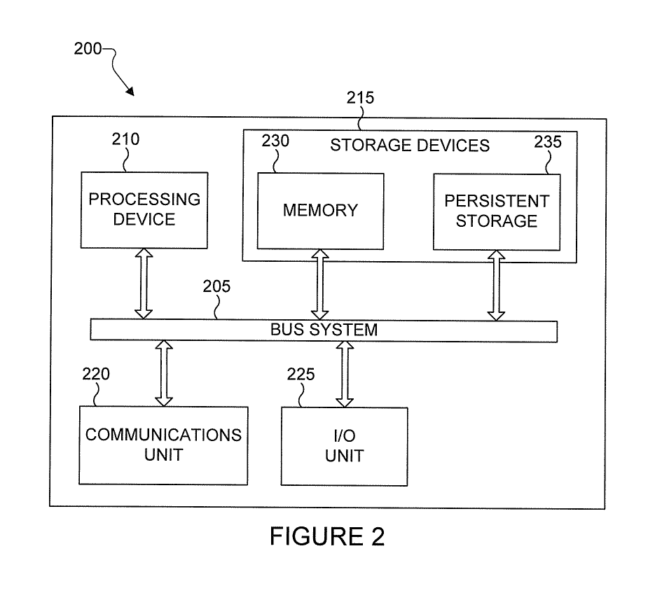

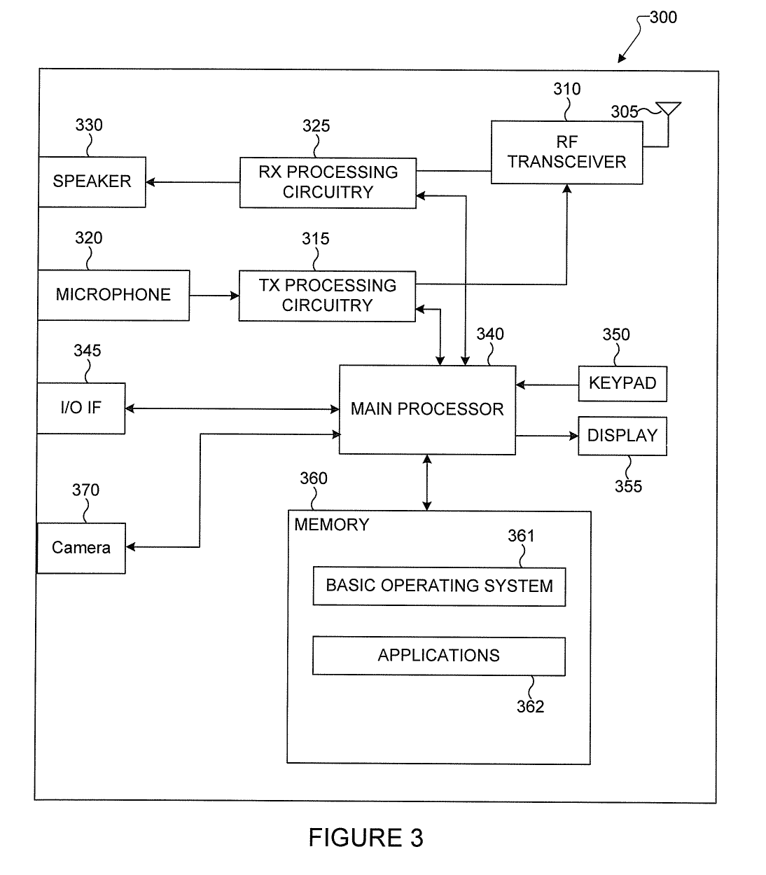

FIGS. 2 and 3 illustrate example devices in a computing system according to this disclosure. In particular, FIG. 2 illustrates an example server 200, and FIG. 3 illustrates an example client device 300. The server 200 could represent the server 104 in FIG. 1, and the client device 300 could represent one or more of the client devices 106-114 in FIG. 1.

In the example shown in FIG. 2, the server 200 includes a bus system 205 that supports communication between at least one processing device 210, at least one storage device 215, at least one communications unit 220, and at least one input/output (I/O) unit 225. The storage device 215 can include a memory 230 and a persistent storage 235. The server 200 is configured to provide management of professional certifications and license compliance.

The processing device 210 executes instructions that can be loaded into the memory 230. The processing device 210 includes any suitable number(s) and type(s) of processors or other devices in any suitable arrangement. Example types of processing devices 210 include microprocessors, microcontrollers, digital signal processors, field programmable gate arrays, application specific integrated circuits, and discreet circuitry.

The memory 230 and the persistent storage 235 are examples of storage devices 215, which represent any structure(s) capable of storing and facilitating retrieval of information (such as data, program code, and/or other suitable information on a temporary or permanent basis). The memory 230 can represent a random access memory or any other suitable volatile or non-volatile storage device(s). The persistent storage 235 can contain one or more components or devices supporting longer-term storage of data, such as a ready only memory, hard drive, Flash memory, or optical disc.

The communications unit 220 supports communications with other systems or devices. For example, the communications unit 220 could include a network interface card or a wireless transceiver facilitating communications over the network 102. The communications unit 220 can support communications through any suitable physical or wireless communication link(s).

The I/O unit 225 allows for input and output of data. For example, the I/O unit 225 can provide a connection for user input through a keyboard, mouse, keypad, touchscreen, electronic pen (E-Pen), voice input or other suitable input device. The I/O unit 225 also can send output to a display, printer, or other suitable output device.

Note that while FIG. 2 is described as representing the server 104 of FIG. 1, the same or similar structure could be used in one or more of the client devices 106-114. For example, a laptop or desktop computer could have the same or similar structure as that shown in FIG. 2.

In the example shown in FIG. 3, the client device 300 includes an antenna 305, a radio frequency (RF) transceiver 310, transmit (TX) processing circuitry 315, a microphone 320, and receive (RX) processing circuitry 325. The client device 300 also includes a speaker 330, a main processor 340, an input/output (I/O) interface (IF) 345, a keypad 350, a display 355, and a memory 360. The memory 360 includes a basic operating system (OS) program 361 and one or more applications 362. In certain embodiments, the client device 300 includes a camera 370.

The RF transceiver 310 receives, from the antenna 305, an incoming RF signal transmitted by another component in a system. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, electronic mail (e-mail), or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the client device 300. For example, the main processor 340 could control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for management of professional certifications and license compliance. The main processor 340 can move data into or out of the memory 360 as required by an executing process. In some embodiments, the main processor 340 is configured to execute the applications 362 based on the OS program 361 or in response to signals received from external devices or an operator. The main processor 340 is also coupled to the I/O interface 345, which provides the client device 300 with the ability to connect to other devices such as laptop computers and handheld computers. The I/O interface 345 is the communication path between these accessories and the main processor 340.

The main processor 340 is also coupled to the keypad 350 and the display unit 355. The operator of the client device 300 can use the keypad 350 to enter data into the client device 300. The display 355 may be a liquid crystal display or other display capable of rendering text and/or at least limited graphics, such as from web sites.

The memory 360 is coupled to the main processor 340. Part of the memory 360 could include a random access memory (RAM), and another part of the memory 360 could include a Flash memory or other read-only memory (ROM).

The camera 370 is coupled to the main processor 340. The camera 370 captures images in response to a user input. The camera 370 can store one or more images in memory 360. In certain embodiments, the client device 300 includes more than one camera 370.

As described in more detail below, the server 104 and client device 300 cooperatively communicate to provide an end user, namely a practitioner, an effective and efficient system to manage compliance requirements for the practitioner's certifications and licenses. The client device 300 provides an intelligent interface to provide timely information regarding compliance requirements, compliance changes, informational notices and critical dates for the practitioner's certifications and licenses. The server 200 is capable of receiving external inputs as well as evaluating internal information to record multiple forms of compliance information as well as provide critical updates to the practitioner via the client device 300. The network 102 supports communication of compliance information between server 104 and one or more client devices 106-114.

Although FIGS. 2 and 3 illustrate examples of devices in a computing system, various changes may be made to FIGS. 2 and 3. For example, various components in FIGS. 2 and 3 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 3 illustrates the client device 300 configured as a mobile telephone or smartphone, client devices could be configured to operate as other types of mobile or stationary devices. In addition, as with computing and communication networks, client devices and servers can come in a wide variety of configurations, and FIGS. 2 and 3 do not limit this disclosure to any particular client device or server.

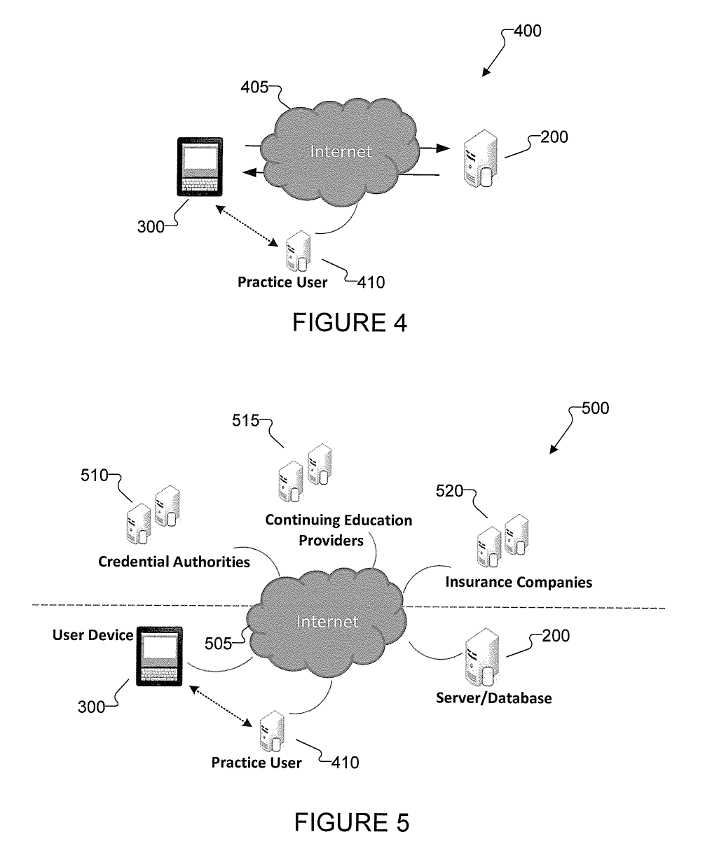

FIG. 4 illustrates a license and certification compliance management platform according to embodiments of the present disclosure. The embodiment of the License and Certification compliance Management Platform (LCMP) 400 shown in FIG. 4 is for illustration only. Other embodiments could be used without departing from the scope of the present disclosure.

The LCMP 400 includes the client device 300 and server 200, which communicate via the network 405. In certain embodiments, the LCMP 400 includes a Practice Device (PD) 410 that communicates with the server 200, the client device 300, or both. For example, the LCMP 400 can include only the client device 300 and server 200, which communicate via the network 405. In another example, LCMP 400 includes only the PD 410 and server 200, which communicate via the network 405. In yet another example, the LCMP 400 includes the client device 300, the PD 410 and server 200, which all communicate via the network 405. In certain embodiments, the client device 300 and the PD 410 are configured to communicate with each other using a second communication link. The second communication link can be wireless or wireline. For example, the the client device 300 and the PD 410 can communicate through one or more of: a direct WiFi, a near-field communication, such as BLUETOOTH, an infrared, a visible light communication, or any suitable wireless communication. In addition, through the disclosure, unless otherwise specified, one or more functions described as being performed by client device 300 can also be performed by PD 410. In addition, one or more communications to or from client device 300 can also be to or from PD 410. In certain embodiments, the PD 410 is configured as the client device 300. In certain embodiments, the PD 410 is configured as single or multi-processor system having one or more connected computer servers. In certain embodiments, the PD 410 comprise one or more servers coupled to one or more client devices 300. For example, the client device 300 can operate as a user interface for the PD 410.

The network 405 could represent the network 102 of FIG. 1. In certain embodiments, the network 405 is a wired network. In certain embodiments, the network is a wireless network 405 utilizing a near field communication link such as a BLUETOOTH connection, or a WiFi connection. For example, network 405 can be formed by one or more client devices 300 forming a Direct WiFi connection with one or more servers 200. In certain embodiments, the network 405 is a combination of wired and wireless communications. The LCMP 400, employing communications via the network 405, provides a mobile portal that allows professional businesses and practitioners to effectively and efficiently manage license and compliance information. A user, such as a practitioner or a supervisor of multiple practitioners can enter compliance requirements and associated expiration or renewal information as well as upload proof of certification documents received from compliance oversight entities.

In certain embodiments, the client device 300 includes an application (APP) configured to enable the user to utilize the LCMP 400. In certain embodiments, the client device 300 includes software that enables the device to act a dedicated interface to the LCMP 400. The client device 300 provides an interface for use by the user to manage license and certification compliance information. The client device 300 interface can be a display and input means, such as a mouse, keyboard, touchscreen, electronic pen (E-Pen), or voice input, or other suitable input device, configured to enable the user to register a practitioner, business entity, or compliance information for use in the LCMP 400.

In certain embodiments, the PD 410 includes an application (APP) or software, namely a plurality of instructions, that, when executed by a processor, cause a processor in the PD 410 to enable the user to utilize the LCMP 400. In certain embodiments, the PD 410 includes software that enables the device to act a dedicated interface to the LCMP 400. The PD 410 provides an interface for use by a Practice having multiple licensed practitioners to manage license and certification compliance information for the multiple practitioners. The PD 410 interface can be a display and input means, such as a mouse, keyboard, touchscreen, electronic pen (E-Pen), or voice input, or other suitable input device, configured to enable the user to register a practitioner, business entity, or compliance information for use in the LCMP 400.

The server 200 includes instructions stored in storage devices 215 and an interface, such as part of I/O unit 225, that receives communications from the client device 300, or PD 410, as well as transmits communications to the client device 300, the PD 410, or both. The server 200 serves as the central repository for all compliance documents and provides the user the ability to electronically share compliance documents with others. In certain embodiments, one or more servers 200 are located at a central facility. For example, one or more servers 200 located in a server facility in a first city, such as Atlanta or Dallas, can provide license and certification compliance management to client devices 300 located in other cities in the United States or in cities in other countries. In certain embodiments, one or more servers 200 are located at a same location in which the practitioners operate, that is, the business or entity where the practitioner provides his or her services. For example, one or more servers 200 can be located in a hospital, an engineering office, a dental office, an accounting office, and so forth.

The user can register, or otherwise setup an account, with the LCMP 400 via the client device 300. If a payment is required, the user also can provide payment to the LCMP 400 via the client device 300. The client device 300 prompts the user to enter account information, such as one or more of: user identifier (ID), name, state, license number, policy number, and so forth. The client device 300 stores the account information in memory 360. In certain embodiments, the account information is retained until manually deleted by the user. In certain embodiments, the account information is deleted automatically, that is, without user interaction and in response to another event occurring such as the lapsing of a specified period of time. The client device 300 transmits the account information to the server 200. The client device 300 displays a message to the user informing the user that the account information has been entered and submitted to the server 200. In certain embodiments, the server 200 transmits a confirmation message to the client device 300. The client device 300 then can display an additional message to the user informing the user that the account information has been recorded by the LCMP 400. In certain embodiments, the client device 300 deletes the account information from memory 360 upon receipt of the confirmation message.

In certain embodiments, the user can register, or otherwise setup a Practice account, with the LCMP 400 via the PD 410. In certain embodiments, the user connects to the LCMP 400 by entering information in the client device 300, which forwards the information to the PD 410. The PD 410 then transmits the information to the server 200. If a payment is required, the user also can provide payment to the LCMP 400 via the PD 410. The PD 410 prompts the user to enter account information, such as one or more of: a group identifier (GID), name, state, license number(s), policy number(s), and so forth. The LCMP 400 enables the user to associate multiple practitioners with the GID. Additionally, a practitioner can be associated with multiple GIDs, such as when the practitioner is associated with multiple practices. In certain embodiments, the LCMP 400 is able to associate an existing account of a practitioner to the GID. For example, in response to the user entering a license number, or other unique identifier, the LCMP 400 locates and retrieves account or compliance information for the practitioner associated with the license number, or other unique identifier, and, upon approval by the user, adds the selected practitioner to the GID. In certain embodiments, upon adding a pre-existing account to a new GID, or removing a practitioner from the GID, the LCMP 400 sends a message to the practitioner added or removed from the account informing the practitioner of the change or requesting approval for the change. The PD 410 stores the account information in a memory. In certain embodiments, the account information is retained until manually deleted by the user. In certain embodiments, the account information is deleted automatically, that is, without user interaction and in response to another event occurring such as the lapsing of a specified period of time. The PD 410 transmits the account information to the server 200. The PD 410 displays a message to the user informing the user that the account information has been entered and submitted to the server 200. In certain embodiments, the server 200 transmits a confirmation message to the PD 410. The PD 410 then can display an additional message to the user informing the user that the account information has been recorded by the LCMP 400. In certain embodiments, the client PD 410 deletes the account information from memory upon receipt of the confirmation message.

The user also is able to update renewal information via the client device 300. The client device 300 displays renewal requirements for one or more licenses or certifications. The user can input payment information into the client device 300. In certain embodiments, the client device 300 stores payment information, such as in memory 360. The client device 300 transmits the payment information to the server 200 or to the credential authority. The client device 300 can display a message informing the user that payment information has been sent to the server 200 or to the credential authority. The server 200, or the credential authority, can transmit a confirmation message to the client device 300. In certain embodiments, the confirmation message is sent to the user via a text message, an e-mail message, a social media communication, a telephonic communication, a paper communication, or a combination thereof.

The user also is able to update renewal information via the PD 410. The PD 410 displays renewal requirements for one or more licenses or certifications. The user can input payment information into the PD 410. In certain embodiments, the PD 410 stores payment information, such as in memory. The PD 410 transmits the payment information to the server 200 or to the credential authority. The PD 410 can display a message informing the user that payment information has been sent to the server 200 or to the credential authority. The server 200, or the credential authority, can transmit a confirmation message to the PD 410. In certain embodiments, the confirmation message is sent to the user via a text message, an e-mail message, a social media communication, a telephonic communication, a paper communication, or a combination thereof.

The user also is able to select and upload continuing education information via the client device 300. The client device 300 displays continuing education requirements for one or more licenses or certifications. The client device 300 displays information regarding one or more continuing education courses offered by a continuing education provider. In certain embodiments, the user can select one or more continuing education courses and enroll in the selected continuing education course via the client device 300. Upon completing the continuing education course, the user uploads proof of completion into the LCMP 400. The proof of completion can include a course completion certificate, a roster of students showing the practitioner's name or ID, or a combination thereof. In certain embodiments, the user can capture an image of the proof of completion using the camera 370. In certain embodiments, the user scans the proof of completion using an external scanner communicatively coupled to the client device 300. In certain embodiments, an electronic image of the proof of completion is transferred to the client device 300, such as from an external computer, external memory, or from the continuing education provider. The client device 300 can display the proof of completion on display 355 to enable the user to review or verify the proof of completion. The client device 300 stores the proof of completion, such as in memory 360. In certain embodiments, the proof of completion is retained until manually deleted by the user. In certain embodiments, the proof of completion is deleted automatically, that is, without user interaction and in response to another event occurring such as the transmission of the proof of completion to the server 200. In response to a user command, the client device 300 transmits the proof of completion to the server 200 or to the credential authority. The client device 300 can display a message informing the user that proof of completion has been sent to the server 200 or to the credential authority. The server 200, or the credential authority, can transmit a confirmation message to the client device 300. In certain embodiments, the confirmation message is sent to the user via a text message, an e-mail message, a social media communication, a telephonic communication, a paper communication, or a combination thereof. In certain embodiments, upon receipt of the confirmation message, the client device 300 deletes the proof of completion from the memory 360. The client device 300 can prompt the user prior to deletion of the proof of completion to confirm or verify that the user concurs with the deletion of the proof of completion. In certain embodiments, the client device 300 maintains a listing of required, planned or completed courses. The client device 300 provides a mobile listing to the user of the required, planned or completed courses. The client device 300 also can maintain and display a notification of expiring, or expired, coursework, coursework deficiencies, continuing education course requirement changes, and associated dates. The client device 300 can synchronize the listing with the server 200 update the continuing education course information, such as the required, planned or completed courses, expiring, or expired, coursework, coursework deficiencies, continuing education course requirement changes, and associated dates, in the client device 300, the server 200 or both. That is, the user can identify new courses to take and add the course to a future planned listing. Upon a synchronization event, the server 200 updates the server listing of the future planned course to include the new course.

The user also is able to select and upload continuing education information via the PD 410. The PD 410 displays continuing education requirements for one or more licenses or certifications for one or more practitioners associated with a Practice, namely associated with a GID. The PD 410 displays information regarding one or more continuing education courses offered by a continuing education provider. In certain embodiments, the user can select one or more continuing education courses and enroll one or more of the practitioners associated with the GID in the selected continuing education course via the PD 410. Upon completing the continuing education course, the user uploads proof of completion into the LCMP 400. The proof of completion can include a course completion certificate, a roster of students showing the practitioner's name or ID, or a combination thereof. In certain embodiments, the user can capture an image of the proof of completion using the camera coupled to, or included in, the PD 410. In certain embodiments, the user scans the proof of completion using an external scanner communicatively coupled to the PD 410. In certain embodiments, an electronic image of the proof of completion is transferred to the PD 410, such as from a client device 300, an external computer, external memory, or from the continuing education provider. In certain embodiments, the practitioner enters the proof into their account via the client device 300 and the LCMP 400 updates the records for all the accounts or GIDs to which the practitioner is associated. The PD 410 can display the proof of completion on a display to enable the user to review or verify the proof of completion. The PD 410 stores the proof of completion, such as in a memory. In certain embodiments, the proof of completion is retained until manually deleted by the user. In certain embodiments, the proof of completion is deleted automatically, that is, without user interaction and in response to another event occurring such as the transmission of the proof of completion to the server 200. In response to a user command, the PD 410 transmits the proof of completion to the server 200 or to the credential authority. The PD 410 can display a message informing the user that proof of completion has been sent to the server 200 or to the credential authority. The server 200, or the credential authority, can transmit a confirmation message to the PD 410. In certain embodiments, the confirmation message is sent to the user via a text message, an e-mail message, a social media communication, a telephonic communication, a paper communication, or a combination thereof. In certain embodiments, upon receipt of the confirmation message, the PD 410 deletes the proof of completion from the memory. The PD 410 can prompt the user prior to deletion of the proof of completion to confirm or verify that the user concurs with the deletion of the proof of completion. In certain embodiments, the PD 410 maintains a listing of required, planned or completed courses for the practitioners associated with the GID. The PD 410 provides a mobile or local listing to the user of the required, planned or completed courses for the practitioners associated with the GID. The PD 410 also can maintain and display a notification of expiring, or expired, coursework, coursework deficiencies, continuing education course requirement changes, and associated dates for the practitioners associated with the GID. The PD 410 can synchronize the listing with the server 200 update the continuing education course information, such as the required, planned or completed courses, expiring, or expired, coursework, coursework deficiencies, continuing education course requirement changes, and associated dates, in the PD 410, in one or more client devices 300, the server 200 or a combination thereof. That is, the user can identify new courses for the practitioners associated with the GID to take and add the course to a future planned listing for one or more practitioners to take. Upon a synchronization event, the server 200 updates the server listing of the future planned course to include the new course.

The server 200 serves as the central repository for all compliance documents and provides the user the ability to electronically share compliance documents with others. The server 200 receives the account information, the renewal information and the continuing education information from the client device 300, the PD 410, or both. In certain embodiments, with prior authorization from the user, the server 200 can receive renewal information or continuing education information from the credential authority or the continuing education provider, or both. The server 200 stores, such as in storage devices 215, the account information, the renewal information and the continuing education information from the client device 300, the PD 410, or both. The server 200 is able to provide the stored information to the client device 300, the PD 410, to the credential authority, or to a third party.

The server 200 further is able to analyze the stored information and provide one or more actions based on such analysis. The server 200 can request additional information, fetch information from a credential authority, continuing education provider or insurance company, or provide notifications to the user's credential authority, continuing education provider or insurance company.

For example, in response to receiving the account information, the server 200 reviews the account information to identify critical dates for action. The server 200 communicates with the credential authority to obtain information necessary to identify the time periods, or dates, for action. That is, in response to the user entering a license, the server 200 identifies the appropriate credential authority based on the type of license and jurisdiction for the license. The server 200 can communicate with the credential authorities to obtain the license requirements or the server 200 can retrieve the license requirements from storage device 215. Based on the license information received from client device 300, the PD 410, or both, and the license requirements, the server 200 identifies the critical dates for renewal and any continuing education requirements, such as required hours, required courses, and the critical dates the hours or courses are due. The server 200 sends the client device a notification regarding the critical dates for renewal and any continuing education requirements. The server 200 can send the notifications periodically or be triggered by the renewal dates. That is, upon a current date falling within a predefined period prior to a renewal date, the server 200 sends the notification to the client device 300, the PD 410, or both. The notification can be a text message, an e-mail message, a social media communication, a telephonic communication, a paper communication, or a combination thereof. The predefined period can be a pre-set number of months, or days, prior to the renewal date, a user-configurable number of days prior to the renewal date, or a user-configurable date. For example, the server 200 can send the notification to the client device 300, the PD 410, or both, thirty days prior to the renewal date. In another example, the user, via the client device 300 or the PD 410, can set the user-configurable number of days to sixty days such that the server 200 sends the notification to the client device sixty days prior to the renewal date. In another example, the user, via the client device 300 or PD 410, can set the user-configurable date to a specific month and day. Therefore, if the renewal date is June 15, the user can set the user-configurable date to May 15 such that the server 200 sends the notification to the client device on May 15. In certain embodiments, the server 200, the PD 410 or the client device 300, informs the user if the user-configurable date is after the renewal date or within a set number of days prior to the renewal date. In certain embodiments, multiple dates prior to the renewal date can be used to trigger the notification. For example, the server 200 can send a new renewal every day from the trigger date to the renewal date. The number of times that the server 200 sends the notification can be pre-set or user-configurable. In certain embodiments, the server 200 records a date, time and entry by the user for the user-configurable entries or for user responses to notifications.

In another example, in response to receiving the account information, the server 200 reviews the account information to identify required continuing education. The server 200 communicates with the credential authority to obtain information necessary to identify required courses, the time periods, or dates, for action. In certain embodiments, the server 200 also obtains completed continuing education from the credential authority or continuing education provider. The server 200 sends a Continuing Education (CE) message to the client device 300 or the PD 410. The CE message includes one or more of: the continuing education coursework required; continuing education coursework available for enrollment; planned continuing education coursework; and completed continuing education coursework.

In response to receiving the proof of completion from the client device 300 or the PD 410, the server 200 stores the proof of completion in the storage device 215, such as in a file associated with the user. In certain embodiments, the server 200 provides the proof of completion to the compliance authority. The server 200 can send the proof of completion to the compliance authority periodically, in response to a user request, or in response to receiving the proof of completion. The server 200 generates the CE message based on the requirements of the license, or certification. The server 200 reviews the stored proofs of completion and generates a listing of completed course work. The server 200 also reviews user inputs to identify future planned courses. The server generates the CE message including one or more of the required continuing education coursework, planned courses and completed coursework. The CE message also can include a notification of expiring, or expired, coursework, coursework deficiencies, continuing education course requirement changes, and associated dates. In certain embodiments, when the client device 300 or the PD 410 maintains a listing of required, planned or completed courses, the server 200 can synchronize the listing and update the continuing education course information in the client device 300, the PD 410, the server 200 or a combination thereof.

The server 200 maintains additional documentation as needed. For example, the server 200 can store insurance information. The user can upload insurance policy information to the server 200 via the client device 300. One or more of the server 200, the client device 300 and the PD 410 can store the insurance information. Additionally, one or more of the server 200, the PD 410 and client device 300 can obtain additional information related to the user's insurance policies from one or more insurance companies. The server 200, the PD 410 or the client device 300, can provide the user critical policy information, such as policy renewal due dates, policy coverages and claim information. In certain embodiments, the user can input claim information into the PD 410 or the client device 300, which sends the claim information to the server 200, the insurance company, or both.

For each compliance requirement, the server 200 sends electronic notifications based on renewal or compliance regulations to help ensure continuity of active credentials. That is, in response to the user entering account information for a practitioner, such as a practitioner ID, name, state, license number(s), policy number, and the like, into the client device 300, the server 200 automatically sends electronic notifications based on renewal or compliance regulations to help ensure continuity of active credentials. In addition, in response to the user entering account information for multiple practitioners in the case of a Practice, such as a practitioner IDs, names, states, license numbers, policy numbers, and the like, into the PD 410, the server 200 automatically sends electronic notifications based on renewal or compliance regulations to help ensure continuity of active credentials. For example, for a Medical or Dental professional, compliance credentials include, but are not limited to the following:

1) Professional Education, state specific both related to content and amount, in some states, the records are maintained by the practitioner, and in some states, the records are maintained in a data base by the state Board;
State Required Continuing Medical Education:
   a) Courses, such as Health Insurance Portability and Accountability Act (HIPPA), HB303, Insurance, Ethics, Basic Life Support, and the like;
   b) Mandatory Continuing Education courses or contact hours, related to maintaining competency in a clinical specialty; and
   c) Elective courses not related to the specific specialty but related to the conducting of business within the ethical bounds of the profession;

2) Licenses:
a) Renewed periodically over different time frames some requiring multiple steps;
b) State or Federal Professional Medical or Dental, (renewal required one or two years from the date of licensure);
c) Federal Drug Enforcement Agency, (renewal required three years from licensure, not synchronized with state license);
d) State Drug,
   In some instances a multi-tier process is required, for example, the State of Texas utilizes a two tier renewal in which a fee is paid online before a paper signed application with the payment reference number attached is mailed; and
   Federal National Provider Information; and

3) Insurance:
a) Liability,
b) Malpractice,
c) Workers Compensation, and
d) Personal or Real Property for business entities such as when the medical or dental professional owns their own facility.

In certain embodiments, the PD 410 is configured to provide an oversight function for managing the licenses and credentials. The PD 410 is configured to authenticate and authorize requests. For example, in response to a practitioner submitting to enroll in a continuing education course, such as by selecting the course or entering the course in a future planned course list, the PD 410 receives a notification that the practitioner has requested the selected course. The user is able to review the course curriculum, the certification to which the course applies and additional associated information regarding the course and the practitioner, and, upon such review, authorize or deny the course via the PD 410. In certain embodiments, the PD 410 is configured to authenticate information and documents entered by one or more practitioners associated with the GID as the information relates to the GID. For example, when a practitioner enters information or certifications into the client device 300, the user can accept or deny the information or certifications via the PD 410. However, such acceptance or denial of the information or certifications is relative only to the account information for the GID and does not alter the information in the practitioners individual account information. In certain embodiments, the PD 410 provides a credential status for the practitioners associated with the GID. The PD 410 displays the credential status for each practitioner enables the user to flag one or more practitioners that are delinquent with regard to the compliance requirements or restrict operational activity as appropriate.

FIG. 5 illustrates a license and certification compliance management network according to embodiments of the present disclosure. The embodiment of the License and Certification compliance Management Network (LCMN) 500 shown in FIG. 5 is for illustration only. Other embodiments could be used without departing from the scope of the present disclosure.

The LCMN 500 includes the LCMP 400, with client device 300 and server 200 that communicate with each other via the network 505. In certain embodiments, the LCMP 400 includes a Practice Device (PD) 410 that communicates with the server 200, the client device 300, or both. For example, the LCMP 400 can include only the client device 300 and server 200, which communicate via the network 405. In another example, LCMP 400 includes only the PD 410 and server 200, which communicate via the network 405. In yet another example, the LCMP 400 includes the client device 300, the PD 410 and server 200, which all communicate via the network 405. In certain embodiments, the client device 300 and the PD 410 are configured to communicate with each other using a second communication link. The second communication link can be wireless or wireline. For example, the the client device 300 and the PD 410 can communicate through one or more of: a direct WiFi, a near-field communication, such as BLUETOOTH, an infrared, a visible light communication, or any suitable wireless communication. In addition, through the disclosure, unless otherwise specified, one or more functions described as being performed by client device 300 can also be performed by PD 410. In addition, one or more communications to or from client device 300 can also be to or from PD 410. In certain embodiments, the PD 410 is configured as the client device 300. In certain embodiments, the PD 410 is configured as single or multi-processor system having one or more connected computer servers. In certain embodiments, the PD 410 comprise one or more servers coupled to one or more client devices 300. For example, the client device 300 can operate as a user interface for the PD 410.

The network 505 could represent the network 102 in FIG. 1 or network 405 of FIG. 4. For example, the network 505 could be all or a portion of a global network such as the Internet. The LCMP 400 also communicates respectively to Credential Authorities (CA) 510, Continuing Education Providers (CEP) 515 and Insurance Companies 520. That is, the client device 300, the PD 410 and server 200 also communicate respectively to Credential Authorities (CA) 510, Continuing Education Providers (CEP) 515 and Insurance Companies 520. For example, the client device 300 can communicate compliance information, such as renewal and completed continuing education information, to CA 510. In another example, the client device 300 can browse continuing education courses and obtain, such as by registration, purchase or on-line completion, continuing education from CEP 515. In another example, the PD 410 can browse continuing education courses and obtain, such as by registration, purchase or on-line completion, continuing education from CEP 515 for one or more practitioners associated with the same Practice. Additionally, the server 200 can communicate compliance information, such as renewal and completed continuing education information, to CA 510 on behalf of the practitioner. In another example, one or more CEP's 515 provide continuing education information to the client device 300 or the PD 410 via the server 200. While the example of the LCMN 500 shown in FIG. 5 includes the CA 510, CEP 515 and Insurance Companies 520, other server networks could be communicably connected without departing from the scope of the present disclosure.

The client device 300 provides an interface that enables license and certification management by a user, such as a practitioner or a supervisor, such as one or more individuals that supervise, manage or oversee one or more practitioners associated with a services based entity such as at a hospital, a doctor's or dentist's office, an engineering firm, an accounting office, an architecture firm, construction company, brokerage firm, and the like. In certain embodiments, the supervisor accesses the LCMN 500 via an interface provided by the client device 300 coupled to the PD 410. The client device 300 interface can be a display and input means, such as a mouse, keyboard, touchscreen, E-Pen, or voice input, or other suitable input device, configured to enable the user to register a practitioner, business entity, or compliance information for use in the LCMN 500. The user utilizes the client device 300 to setup a new account with the LCMN 500 as well as to manage compliance information within the LCMN 500. The client device 300 further enables the user to view credential or compliance information, such as from the CA 510, as well as insurance information received from third party sources, such as from the Insurance Companies 520 and continuing education information, such as from CEP 515. The user also is able to update account information, such as e-mail and phone number(s) and practitioner active credential information. The user can update the account information, such as by adding new credentials, adding completed continuing education, or adding new license information, via the client device 300. The user can receive electronic compliance notifications via the client device 300. In certain embodiments, the user receives compliance information via a text message presented on the display of the client device 300. In certain embodiments, the compliance information is communicated via an e-mail message and the user accesses an e-mail system via the client device to retrieve the compliance information. In certain embodiments, the compliance information is sent via a social media communication, a telephonic communication, a paper communication, or a combination thereof.

The client device 300 provides an interface that enables license and certification management by a user, such as a supervisor of one or more practitioners, manage or oversee one or more practitioners associated with a services based entity such as at a hospital, a doctor's or dentist's office, an engineering firm, an accounting office, an architecture firm, construction company, brokerage firm, and the like. In certain embodiments, the supervisor accesses the LCMN 500 via an interface provided by the client device 300 coupled to the PD 410. The PD 410 interface can be a display and input means, such as a mouse, keyboard, touchscreen, E-Pen, or voice input, or other suitable input device, configured to enable the user to register a practitioner, business entity, or compliance information for use in the LCMN 500. The user utilizes the PD 410 to setup a new group account with the LCMN 500 as well as to manage compliance information for a Practice associated with the group account within the LCMN 500. The PD 410 further enables the user to view credential or compliance information for multiple practitioners associated with a same group ID (GID). The compliance information can be received from multiple sources, such as from the CA 510, as well as insurance information received from third party sources, such as from the Insurance Companies 520 and continuing education information, such as from CEP 515. The user also is able to update account information, such as e-mail and phone number(s) and practitioner active credential information. The user can update the account information, such as by adding new practitioners, adding new credentials, adding completed continuing education, or adding new license information, via the PD 410. The user can receive electronic compliance notifications via the PD 410. In certain embodiments, the user receives compliance information via a text message presented on the display of the PD 410. In certain embodiments, the compliance information is communicated via an e-mail message and the user accesses an e-mail system via the client device to retrieve the compliance information. In certain embodiments, the compliance information is sent via a social media communication, a telephonic communication, a paper communication, or a combination thereof.

The server 200 receives information, such as account information, license information and inquiries, from the client device 300 or the PD 410. Based on the account information entered by the user, the server 200 communicates with one or more of the CA 510, CEP 515 and Insurance Companies 520. The account information received from the client device 300, for example, namely the account information entered on the client device 300 by the user, includes one or more of: name, state, license number, policy number, and so forth. The server 200 utilizes the account information received from the client device 300, or received from the PD 410, to fetch compliance information from one or more of the CA 510 and CEP 515 or insurance related information from the Insurance Companies 520. The server 200 can fetch the compliance information or insurance information in response to a user request received via the client device 300 or from the PD 410. The server 200 also can perform an auto-fetch in which the server automatically, that is, without additional user intervention, fetches the compliance information or insurance information periodically. The server 200 can perform the auto-fetch periodically to maintain the compliance information or insurance information as current. The server 200 stores information and documents. For example, the server 200 can store compliance requirement information, course completion documents, copies of certifications, copies of licenses, user ID information, insurance information, continuing education curriculum information, historical information, and the like. The server 200 updates validation parameters, such as renewal requirements and sends automated electronic notifications, which can be sent in response to a renewal date. That is, in response to determining that a current date is within a predefined period preceding a specified renewal date, the server 200 sends one or more notifications to the client device 200 regarding the upcoming renewal date.

The server 200 serves as the central repository for all compliance documents and provides the user the ability to electronically share compliance documents with others. For example, the server 200 receives compliance documents from the client device 300 or PD 410 and shares the compliance documents with CA 510.

The CA 510 represents one or more servers at authorities that regulate or otherwise implement requirements for certifications, registrations or licenses of a practitioner. The servers could represent the server 104 in FIG. 1 or server 200 of FIG. 2. The CA 510 can include a number of different credential authorities. The different credential authorities can be located in different locations, provide compliance regulation for different fields of service; be managed by different entities, such as different state government agencies, a federal government agency, and a professional board. For example, a first credential authority 510 server or system can be managed, or owned and operated, by a state agency while a second credential authority 510 server or system can be managed, or owned and operated, by a professional board. In another example, a first credential authority 510 server or system can be managed, or owned and operated, by a state bar for legal services while a second credential authority 510 server or system can be managed, or owned and operated, by a medical board for medical services and a third credential authority 510 server or system can be managed, or owned and operated, by a dental board for dental services. The CA 510 receives fetch requests from the server 200. The CA 510 authenticates the fetch request, and in response to determining that the received fetch request is authenticate or valid, sends the requested information to the server 200.

The CEP 515 represents servers at entities that provide continuing education courses to the practitioner. The servers could represent the server 104 in FIG. 1 or server 200 of FIG. 2. The CEP 515 can include a number of different continuing education providers. The different continuing education providers can be located in different locations, provide continuing education for different fields of service; be managed by different entities. One or more CEPs 515 can provide continuing education for more than one type of certification or one type of license. The CEP 515 receives fetch requests from the server 200. The CEP 515 authenticates the fetch request, and in response to determining that the received fetch request is authenticate or valid, sends the requested information to the server 200.

The Insurance Companies 520 represents servers at entities that provide insurance to the practitioner or to a business. The servers could represent the server 104 in FIG. 1 or server 200 of FIG. 2. The Insurance Companies 520 can include a number of different insurance providers. The different insurance providers can be located in different locations, provide insurance of different types for different fields of service; be managed by different entities. One or more Insurance Companies 520 can provide more than one type of insurance for more than one type of user, such as a professional business or a practitioner. The Insurance Company 520 receives fetch requests from the server 200. The Insurance Company 520 authenticates the fetch request, and in response to determining that the received fetch request is authenticate or valid, sends the requested information to the server 200.

The server 200 stores documentation related to one or more practitioner licenses and certification compliance requirements. After the user has uploaded account information, the server 200 periodically, or in response to manual input by the user or an operator, fetches compliance information from the CA 510. The CA 510 sends compliance information in response to the fetch request from the server 200. The compliance information includes renewal dates, renewal amounts, continuing education requirements, continuing education dates, and the like. In certain embodiments, the CA 510 also sends changes in compliance laws or regulations. That is, in response to a change in the law or regulation, or upon an operator updating a law or regulation, the CA 510 sends the change in the law or regulation to the server 200. The server 200 stores the compliance information, such as in storage device 215. The server 200 reviews the compliance information and compares the newly received compliance information to one or more of: a current date and information previously sent to client device 300 or to the PD 410. If the server 200 identifies that a current date is within a predefined threshold of one or more renewal dates or continuing education requirement dates, the server 200 sends a notification to the client device 300 or to the PD 410 indicating the approaching date and corresponding requirement. If the server 200 identifies that currently stored compliance information does not match compliance information previously sent to the client device 300, or to the PD 410, the server 200 sends an informational message to the client device 300. For example, in response to a change in the law or regulation, the server 200 sends a regulation update message to the client device 300 informing the client device 300 regarding one or more of: 1) a change in law or regulation has occurred; 2) a location where the change in law can be found; 3) full text of the change in law or regulation; 4) a summary of the change in law or regulation; and 5) a change in continuing education requirements. In another example, in response to a change in the law or regulation, the server 200 sends a regulation update message to the PD 410 informing the PD 410 regarding one or more of: 1) a change in law or regulation has occurred; 2) a location where the change in law can be found; 3) full text of the change in law or regulation; 4) a summary of the change in law or regulation; and 5) a change in continuing education requirements. In certain embodiments, the server 200 synchronizes with the client device 300 or PD 410 and updates one or more compliance requirements. For example, in response to a change in law or regulation, the server 200 synchronizes with the client device 300 to update a continuing education requirement. Thereafter, the client device 300 and PD 410 are able to indicate to the user the change in continuing education requirements, such as a specified course no longer being applicable to a certification, a date in which the course is no longer applicable or in which a new course must be completed, and a replacement course that is now required. The server 200 also records any response, if a response is required or available, that the user enters in response to a notification sent to the client device 300 or PD 410.

The server 200 stores continuing education information. The continuing education information includes: courses completed, completion dates, course expiration date, courses required, providers, course attendance amounts, course descriptions, corresponding certifications, a planned curriculum and the like. The server 200 receives portions of continuing education information from the CA 510, the CEP 515, PD 410 and client device 300. After the user has uploaded account information, the server 200 also periodically, or in response to manual input by the user or an operator, fetches continuing education information from the CEP 515. The CEP 515 sends continuing education information, such as courses offered, course description, course locations, course options, and course cost, in response to the fetch request from the server 200. In certain embodiments, the CA 510 also sends changes in continuing education requirements, such as in response to a change in compliance laws or regulations. The server 200 stores the continuing education information, such as in storage device 215. The server 200 maintains the continuing education information with respect to each user and can provide, or transmit, the continuing education information to the client device 300 or to the PD 410. The server 200 reviews the continuing education information and updates the continuing education information in response to fetch requests and updates from one or more of the CA 510, CEP 515, the PD 410 and client device 300. The server 200 compares the stored continuing education information with compliance requirements to identify if any course, or “skill” associated with the course, is scheduled to expire, such as having an expiration date or a valid date or such as based on a timeframe from when the course was completed. When the server 200 identifies that a current date is within a predefined threshold of an expiration renewal date, the server 200 sends a notification to the client device 300, the PD 410, or both, indicating the approaching date and corresponding course or skill. If the server 200 identifies a change in continuing education requirement, such as in response to a change in a compliance law or regulation, the server 200 sends an informational message to the client device 300, the PD 410, or both. For example, in response to a change in the law or regulation, the server 200 sends a continuing education update message to the client device 300 informing the client device 300 regarding one or more of: 1) a change in law or regulation has occurred; 2) a location where the change in law can be found; 3) full text of the change in law or regulation; 4) a summary of the change in law or regulation; and 5) a change in continuing education requirements. In another example, in response to a change in the law or regulation, the server 200 sends a continuing education update message to the PD 410 informing the PD 410 regarding one or more of: 1) a change in law or regulation has occurred; 2) a location where the change in law can be found; 3) full text of the change in law or regulation; 4) a summary of the change in law or regulation; and 5) a change in continuing education requirements. In certain embodiments, the server 200 synchronizes with the client device 300 or PD 410 and updates one or more continuing education requirements. Thereafter, the client device 300 and PD 410 are able to indicate to the user the change in continuing education requirements, such as a specified course no longer being applicable to a certification, a date in which the course is no longer applicable or in which a new course must be completed, and a replacement course that is now required. The server 200 also records any response, if a response is required or available, that the user enters in response to a notification sent to the client device 300 or PD 410. In certain embodiments, the server 200 maintains a future course list. In response to the user selecting a course from a course listing, the client device 300 sends a message to the server 200 that the user would like to add the selected course to a list of courses that the user would like to take at a future date. In certain embodiments, the PD 410 must approve the request to add the course prior to server action. The client device 300 can send the request directly to the PD 410 or the server 200 can inform the PD 410 regarding the request and solicit approval from the PD 410. In response, the server 200 generates and maintains a future course list, which can be further updated in response to communications with CEP 515. That is, the server 200 updates course descriptions, dates and locations for courses on the future course list such as via fetch requests to CEP 515 or in response to updates received from CEP 515.

The server 200 also stores documentation related to one or more practitioner insurance policies. The user inputs insurance policy information into the client device 300 or the PD 410. In certain embodiments, the user enters a policy number and corresponding insurance company into an “insurance” panel on the client device. In certain embodiments, the client device 300 includes an APP associated with an insurance company and the client device 300 is configured to associate an LCMP APP with the insurance APP or extract the policy number and corresponding insurance company from the insurance APP. In certain embodiments, the PD 410 includes software or a web-portal associated with an insurance company and the PD 410 is configured to associate LCMP software with the insurance software or a web-portal or extract the policy number and corresponding insurance company from the insurance software or a web-portal. In certain embodiments, the user can capture an image of the insurance policy such as by using the camera 370. In certain embodiments, the user scans the insurance policy using an external scanner communicatively coupled to the client device 300. In certain embodiments, an electronic image of the insurance policy is transferred to the client device 300, such as from an external computer, external memory, or from the Insurance Company 520. The client device 300 transmits insurance policy information, namely the policy number and corresponding insurance company, to the server 200, which stores insurance policy information. The server 200 can communicate with Insurance Companies 520 to obtain insurance policy coverage information, such as policy dates, policy coverages, policy terms, and the like. One or more of the server 200 and client device 300 can store the insurance information. Additionally, one or more of the server 200 and client device 300 can obtain additional information related to the user's insurance policies from one or more Insurance Companies 520. The server 200, PD 410 or the client device 300, provides the user critical policy information, such as policy renewal due dates, policy coverages and claim information. In certain embodiments, the user can input claim information into the client device 300, which sends the claim information to the server 200, the Insurance Company 520, or both. In certain embodiments, with authorization from the user, the Insurance Company 520, or both, in response to receiving claim information from the client device 300, the server 200 sends the claim information to the Insurance Company 520.

The client device 300 communicates with one or more of: the server 200, the CA 510, the CEP 515 and the Insurance Companies 520. In certain embodiments, the client device 300 also communicates with the PD 410. The client device 300 provides an interface that enables the user to setup an account with the LCMP 400, review compliance requirements, renew and update licenses and certifications; enter new licenses and certifications; review continuing education requirements; update continuing education requirements; plan continuing education courses; acquire continuing education courses; review insurance requirements or suggestions; review insurance policies; acquire insurance coverage; review insurance coverages; input and review insurance claim information; and renew or update insurance policies. The user can add new licenses or certifications, continuing education information and insurance information through client device 300. The client device 300 sends the new licenses or certifications, continuing education information and insurance information to the server 200 and a respective one or more of the CA 510, CEP 515 and Insurance Companies 520.

The PD 410 communicates with one or more of: the server 200, the CA 510, the CEP 515 and the Insurance Companies 520. In certain embodiments, the PD 410 also communicates with one or more client devices 300. The PD 410 provides an interface that enables the user to setup a group account with the LCMP 400, add practitioners to be associated with the group account, review compliance requirements for multiple practitioners associated with the group account, renew and update licenses and certifications for multiple practitioners associated with the group account; enter new licenses and certifications for multiple practitioners associated with the group account; review continuing education requirements for multiple practitioners associated with the group account; update continuing education requirements for multiple practitioners associated with the group account; plan continuing education courses for multiple practitioners associated with the group account; acquire continuing education courses for multiple practitioners associated with the group account; review insurance requirements or suggestions; review insurance policies; acquire insurance coverage; review insurance coverages; input and review insurance claim information; and renew or update insurance policies. The user can add new practitioners, new licenses or certifications, continuing education information and insurance information for multiple practitioners associated with the group account through PD 410. The PD 410 sends the new licenses or certifications, continuing education information and insurance information to the server 200 and a respective one or more of the CA 510, CEP 515 and Insurance Companies 520. In certain embodiments, the server 200 is able to identify that an added practitioner already has an account profile. The server 200 then associates the account information for the added practitioner with the GID. It is noted that a GID can include any number of practitioners and that a practitioner can be associated with multiple different GIDs.

The client device 300 receives and displays compliance information from the server 200, the CA 510 or both. The compliance information includes renewal dates, renewal amounts, continuing education requirements, continuing education dates, and the like. In certain embodiments, the compliance information includes changes in compliance laws or regulations. In certain embodiments, the client device 300 communicates only with the server 200 to obtain compliance information. In certain embodiments, the client device 300 receives only basic compliance information from the server 200, such as identifying a compliance authority, compliance address, compliance web-portal, namely a hypertext transport protocol (HTTP) address, and the like. The client device 300 then communicates directly with CA 510 to obtain compliance information. In certain embodiments, the client device 300 stores user account information such as, user ID, name, state, license number, policy number, and so forth. The client device 300 can send the user account information to the server for accessing compliance information from the CA 510 or the client device 300 can send the user account information for a respective compliance authority to the CA 510 to access the compliance information from that compliance authority. For example, the client device 300 can store account information for different compliance authorities wherein each compliance authority regulates a different license or certification of the user. When the user seeks to access compliance information regarding a first license regulated by a first compliance authority, the client device 300, or the server 200 when the client device 300 only communicates with the server 200, sends first account information such as a first user ID for the first compliance authority or a first license number associated with the first license. When the user seeks to access compliance information regarding a second license regulated by a second compliance authority, the client device 300, or the server 200 when the client device 300 only communicates with the server 200, sends second account information such as a second user ID for the second compliance authority or a second license number associated with the second license. The first user ID can be the same or different from the second user ID. When adding a new license or certification, the client device 300 can receive information from the user indicating the respective compliance authority, such as from the user or from a database stored in the client device or at the server 200. That is, based on information associated with the license or certification, the server 200 can provide the user, via a display on the client device 300, suggestions as to probable compliance authorities for the new license or certification.

In certain embodiments, the client device 300 stores the compliance information in memory 360. In certain embodiments, the client device 300 reviews the compliance information and compares one or more dates in the compliance information to a current date. When the client device 300 identifies that a current date is within a predefined threshold of one or more renewal dates, the client device 300 displays a notification to the client device 300 indicating the approaching date and corresponding requirement. In certain embodiments, the client device 300 receives and displays a notification from the server 200 that indicates one or more of: an upcoming renewal date or an update in compliance information, such as an update in a compliance law or regulation including one or more of: 1) a change in law or regulation has occurred; 2) a location where the change in law can be found; 3) full text of the change in law or regulation; 4) a summary of the change in law or regulation; and 5) a change in continuing education requirements. In certain embodiments, the client device 300 synchronizes with the server 200 and updates one or more compliance requirements. For example, the client device 300 can synchronize with the server 200 and be informed regarding an update in a compliance requirement, such as a continuing education requirement. Thereafter, the client device 300 indicates to the user the change in continuing education requirements, such as a specified course no longer being applicable to a certification, a date in which the course is no longer applicable or in which a new course must be completed, and a replacement course that is now required.

The PD 410 receives and displays compliance information for the practitioners associated with the GID from the server 200, the CA 510 or both. The compliance information includes renewal dates, renewal amounts, continuing education requirements, continuing education dates, and the like. In certain embodiments, the compliance information includes changes in compliance laws or regulations. In certain embodiments, the PD 410 communicates only with the server 200 to obtain compliance information. In certain embodiments, the PD 410 receives only basic compliance information from the server 200, such as identifying a compliance authority, compliance address, compliance web-portal, namely a hypertext transport protocol (HTTP) address, and the like. The PD 410 then communicates directly with CA 510 to obtain compliance information. In certain embodiments, the PD 410 stores user account information such as, user ID, name, state, license number, policy number, and so forth. The PD 410 can send the user account information to the server for accessing compliance information from the CA 510 or the PD 410 can send the user account information for a respective compliance authority to the CA 510 to access the compliance information from that compliance authority. For example, the PD 410 can store account information for different compliance authorities wherein each compliance authority regulates a different license or certification of the user. When the user seeks to access compliance information regarding a first license regulated by a first compliance authority, the PD 410, or the server 200 when the PD 410 only communicates with the server 200, sends first account information such as a first user ID for the first compliance authority or a first license number associated with the first license. When the user seeks to access compliance information regarding a second license regulated by a second compliance authority, the PD 410, or the server 200 when the PD 410 only communicates with the server 200, sends second account information such as a second user ID for the second compliance authority or a second license number associated with the second license. The first user ID can be the same or different from the second user ID. When adding a new license or certification, the PD 410 can receive information from the user indicating the respective compliance authority, such as from the user or from a database stored in the client device or at the server 200. That is, based on information associated with the license or certification, the server 200 can provide the user, via a display on the PD 410, suggestions as to probable compliance authorities for the new license or certification.

In certain embodiments, the PD 410 stores, in a memory, the compliance information for the practitioners associated with the GID. In certain embodiments, the PD 410 reviews the compliance information and compares one or more dates in the compliance information to a current date. When the PD 410 identifies that a current date is within a predefined threshold of one or more renewal dates, the PD 410 displays a notification to the PD 410 indicating the approaching date and corresponding requirement. In certain embodiments, the PD 410 receives and displays a notification from the server 200 that indicates one or more of: an upcoming renewal date or an update in compliance information, such as an update in a compliance law or regulation including one or more of: 1) a change in law or regulation has occurred; 2) a location where the change in law can be found; 3) full text of the change in law or regulation; 4) a summary of the change in law or regulation; and 5) a change in continuing education requirements. In certain embodiments, the PD 410 synchronizes with the server 200 and updates one or more compliance requirements. For example, the PD 410 can synchronize with the server 200 and be informed regarding an update in a compliance requirement, such as a continuing education requirement. Thereafter, the PD 410 indicates to the user the change in continuing education requirements, such as a specified course no longer being applicable to a certification, a date in which the course is no longer applicable or in which a new course must be completed, and a replacement course that is now required.

The client device 300 receives and displays continuing education information from the user, the server 200, the CA 510, the CEP 515, or a combination thereof. The client device 300 stores all or a portion of the continuing education information. The continuing education information includes courses completed, completion dates, course expiration date, courses required, providers, course attendance amounts, course descriptions, corresponding certifications, a planned curriculum and the like. The client device 300 receives portions of continuing education information from the CA 510, the CEP 515 and client device 300. The server 200 provides notices and updates to the client device 00 regarding continuing education requirements and changes. In certain embodiments, the CEP 515 sends continuing education information, such as courses offered, course description, course locations, course options, and course cost. In certain embodiments, the server 200 provides the continuing education information from the CEP 515 such as by displaying a banner advertisement on a display of the client device 300. The banner advertisement can indicate one or more of: courses offered by the CEP 515, course descriptions, course locations, course options, and course cost. The course options can include online availability and course material download capabilities. In certain embodiments, the client device 300 indicates changes in continuing education requirements. The changes in continuing education requirements can be received from either the server 200 or the CA 510, such as in response to a change in compliance laws or regulations. In certain embodiments, the client device 300 reviews the continuing education information and updates the continuing education information in response a synchronization event with the server 200. The server 200 (or the client device 300 if equipped to update the continuing education information) compares the stored continuing education information with compliance requirements to identify if any course, or “skill” associated with the course, is scheduled to expire, such as having an expiration date or a valid date or such as based on a timeframe from when the course was completed. When the server 200 identifies that a current date is within a predefined threshold of an expiration renewal date, the server 200 sends a notification to the client device 300 indicating the approaching date and corresponding course or skill. When the server 200 identifies a change in continuing education requirement, such as in response to a change in a compliance law or regulation, the server 200 sends an informational message to the client device 300. For example, in response to a change in the law or regulation, the server 200 sends a continuing education update message to the client device 300 informing the client device 300 regarding one or more of: 1) a change in law or regulation has occurred; 2) a location where the change in law can be found; 3) full text of the change in law or regulation; 4) a summary of the change in law or regulation; and 5) a change in continuing education requirements. Thereafter, the client device 300 indicates to the user the change in continuing education requirements, such as a specified course no longer being applicable to a certification, a date in which the course is no longer applicable or in which a new course must be completed, a replacement course that is now required, and a ratio of allowable online study and self-study, such as a maximum percentage of online study or a maximum percentage of self-study. In certain embodiments, the user can elect to ignore the change in continuing education requirement. In response to the user electing to ignore the change, the client device 300 transmits a message to the server 200, which records that the user chose to ignore the change.

In certain embodiments, the user can update continuing education information via the client device 300. The user can identify one or more continuing education requirements via a listing displayed by the client device 300. In certain embodiments, since a particular CE course can satisfy the requirements for multiple credentials, the LCMP 400 is able to optimize a current education portfolio by suggesting one or more CE courses. In certain embodiments, the server 200 suggests courses by analyzing the portfolio of credentials and suggests a CE plan with the fewest unique courses. In certain embodiments, the client device 300 suggests courses by analyzing the portfolio of credentials and suggests a CE plan with the fewest unique courses. In certain embodiments, the practice device 410 suggests courses by analyzing the portfolio of credentials and suggests a CE plan with the fewest unique courses. In certain embodiments, the user can select one or more courses from the listing of courses displayed by the client device 300 and, in response to selecting the one or more course, be able to obtain more information regarding the course, plan to take the course, purchase the course, or otherwise enroll in the course. For example, upon selecting a course from the listing, the client device 300 can send a message to the server 200 that the user would like to add the selected course to a list of courses that the user would like to take at a future date. In response, the server 200 generates and maintains a future course list, which can be further updated in response to communications with CEP 515. The user also can purchase, or otherwise enroll, in the selected course. For example, in response to the user selecting a course, the user can be connected to the CEP 515 to review more detailed course information and complete a purchase or enrollment. After attending or completing the course, the user uploads proof of completion into the client device 300. The proof of completion can include a course completion certificate, a roster of students showing the practitioner's name or ID, or a combination thereof. In certain embodiments, the user can capture an image of the proof of completion using the camera 370. In certain embodiments, the user scans proof of completion using an external scanner communicatively coupled to the client device 300. In certain embodiments, an electronic image of the proof of completion is transferred to the client device 300, such as from an external computer, external memory, or from the continuing education provider. The client device 300 displays the proof of completion on display 355 to enable the user to review or verify the proof of completion. The client device 300 stores the proof of completion, such as in memory 360. In certain embodiments, the proof of completion is retained until manually deleted by the user. In certain embodiments, the proof of completion is deleted automatically, that is, without user interaction and in response to another event occurring such as the transmission of the proof of completion to the server 200. In response to a user command, the client device 300 transmits the proof of completion to the server 200 or to CA 510. The client device 300 can display a message informing the user that proof of completion has been sent to the server 200 or to the credential authority 510. The client device 300 can display a confirmation message that the proof of completion has been sent and recorded. In certain embodiments, upon receipt of the confirmation message, the client device 300 deletes the proof of completion from the memory 360. The client device 300 can prompt the user prior to deletion of the proof of completion to confirm or verify that the user concurs with the deletion of the proof of completion. In certain embodiments, the client device 300 maintains a listing of required, planned or completed courses. The client device provides a mobile listing to the user of the required, planned or completed courses. The client device 300 also can maintain and display a notification of expiring, or expired, coursework, coursework deficiencies, continuing education course requirement changes, and associated dates. The client device can synchronize the listing with the server 200 update the continuing education course information, such as the required, planned or completed courses, expiring, or expired, coursework, coursework deficiencies, continuing education course requirement changes, and associated dates, in the client device 300, the server 200 or both.

The client device 300 also stores and displays documentation related to one or more practitioner insurance policies received from the user, the server 200, the Insurance Company 520, or both. The client device 300 stores all or a portion of the insurance policies in memory 360. The user can input insurance policy information into the client device 300 or download insurance policy information from the Insurance Company 520. In certain embodiments, the user enters a policy number and corresponding insurance company into an “insurance” panel on the client device. In certain embodiments, the client device 300 includes an APP associated with an insurance company and the client device 300 is configured to associate an LCMP APP with the insurance APP or extract the policy number and corresponding insurance company from the insurance APP. In certain embodiments, the user can capture an image of the insurance policy using the camera 370. In certain embodiments, the user scans the insurance policy using an external scanner communicatively coupled to the client device 300. In certain embodiments, an electronic image of the insurance policy is transferred to the client device 300, such as from an external computer, external memory, or from the Insurance Company 520. The client device 300 transmits insurance policy information, namely the policy number and corresponding insurance company, to the server 200, which stores insurance policy information. The client device 300, or the server 200, can communicate with Insurance Companies 520 to obtain insurance policy coverage information, such as policy dates, policy coverages, policy terms, and the like. In certain embodiments, the server 200 stores the insurance information. Additionally, one or more of the server 200 and client device 300 can obtain additional information related to the user's insurance policies from one or more Insurance Companies 520. The client device 300 provides the user critical policy information, such as policy renewal due dates, policy coverages and claim information. In certain embodiments, the user can input claim information into the client device 300, which sends the claim information to the server 200, the Insurance Company 520, or both. In certain embodiments, the user can enter authorization information to allow the server 200 to send the claim information to the Insurance Company 520.

In certain embodiments, the PD 410 is configured with the same or similar functionality as the client device 300. For example, the PD 410 receives and displays continuing education information from the user, the server 200, the CA 510, the CEP 515, or a combination thereof. The PD 410 stores all or a portion of the continuing education information for multiple practitioners associated with a same GID, namely a same Practice. Additionally, the user can update continuing education information for multiple practitioners via the PD 410 using communications and processes as described with respect to the client device 300. The PD 410 also is able to store and display documentation related to one or more practitioner insurance policies received from the user, the server 200, the Insurance Company 520, or both.

The user also is able to select and upload continuing education information via the PD 410. The PD 410 displays continuing education requirements for one or more licenses or certifications for one or more practitioners associated with a Practice, namely associated with a GID. The PD 410 displays information regarding one or more continuing education courses offered by a continuing education provider 515. In certain embodiments, the user can select one or more continuing education courses and enroll one or more of the practitioners associated with the GID in the selected continuing education course via the PD 410. Upon completing the continuing education course, the user uploads proof of completion into the LCMP 400. The proof of completion can include a course completion certificate, a roster of students showing the practitioner's name or ID, or a combination thereof. In certain embodiments, the user can capture an image of the proof of completion using the camera coupled to, or included in, the PD 410. In certain embodiments, the user scans the proof of completion using an external scanner communicatively coupled to the PD 410. In certain embodiments, an electronic image of the proof of completion is transferred to the PD 410, such as from a client device 300, an external computer, external memory, or from the continuing education provider 515. In certain embodiments, the practitioner enters the proof into their account via the client device 300 and the LCMP 400 updates the records for all the accounts or GIDs to which the practitioner is associated. The PD 410 can display the proof of completion on a display to enable the user to review or verify the proof of completion. The PD 410 stores the proof of completion, such as in a memory. In certain embodiments, the proof of completion is retained until manually deleted by the user. In certain embodiments, the proof of completion is deleted automatically, that is, without user interaction and in response to another event occurring such as the transmission of the proof of completion to the server 200. In response to a user command, the PD 410 transmits the proof of completion to the server 200 or to the credential authority 510. The PD 410 can display a message informing the user that proof of completion has been sent to the server 200 or to the credential authority. The server 200, or the credential authority 510, can transmit a confirmation message to the PD 410. In certain embodiments, the confirmation message is sent to the user via a text message, an e-mail message, a social media communication, a telephonic communication, a paper communication, or a combination thereof. In certain embodiments, upon receipt of the confirmation message, the PD 410 deletes the proof of completion from the memory. The PD 410 can prompt the user prior to deletion of the proof of completion to confirm or verify that the user concurs with the deletion of the proof of completion. In certain embodiments, the PD 410 maintains a listing of required, planned or completed courses for the practitioners associated with the GID. The PD 410 provides a mobile or local listing to the user of the required, planned or completed courses for the practitioners associated with the GID. The PD 410 also can maintain and display a notification of expiring, or expired, coursework, coursework deficiencies, continuing education course requirement changes, and associated dates for the practitioners associated with the GID. The PD 410 can synchronize the listing with the server 200 update the continuing education course information, such as the required, planned or completed courses, expiring, or expired, coursework, coursework deficiencies, continuing education course requirement changes, and associated dates, in the PD 410, in one or more client devices 300, the server 200 or a combination thereof. That is, the user can identify new courses for the practitioners associated with the GID to take and add the course to a future planned listing for one or more practitioners to take. Upon a synchronization event, the server 200 updates the server listing of the future planned course to include the new course.

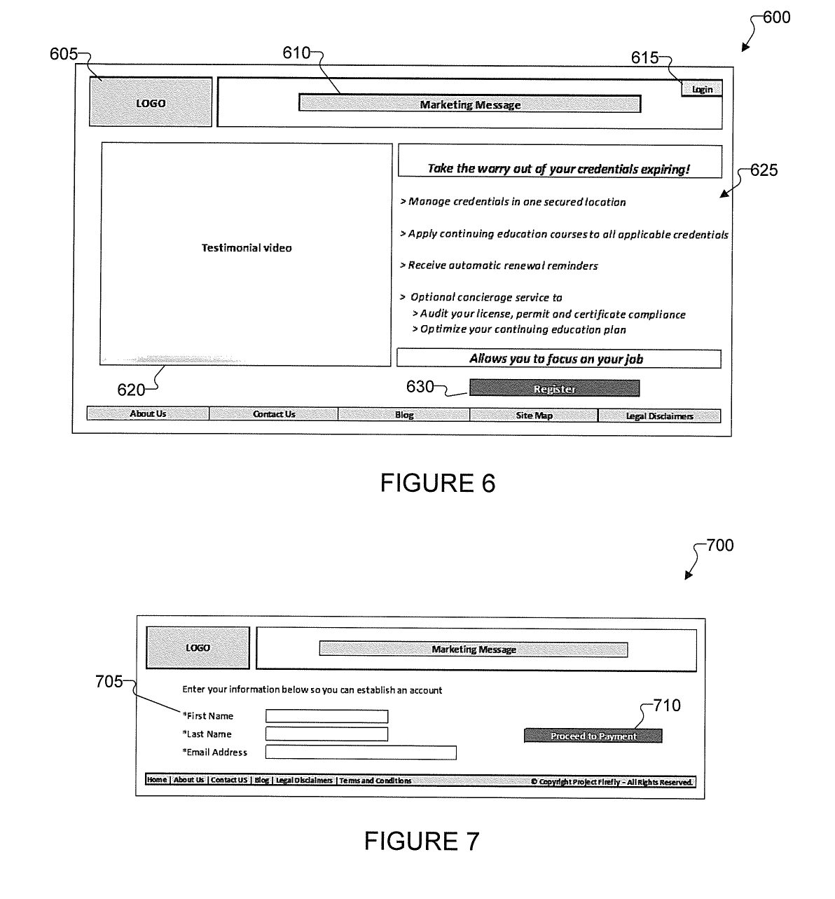

FIGS. 6 through 16 illustrate example displays for the client device according to embodiments of the present disclosure. The embodiments of the displays shown in FIGS. 6 through 16 are for illustration only. Other embodiments could be used without departing from the scope of the present disclosure. In certain embodiments, one or more of the displays in FIGS. 6 through 16 are stored on the client device 300; in which case, the client device 300 retrieves, such as from memory 360, and displays the respective page. In certain embodiments, one or more of the displays in FIGS. 6 through 16 are stored on the server 200; in which case, the client device 300 retrieves the respective page from the server as needed and displays the page after downloading the page from the server 200. The client device 300 also can cache one or more pages downloaded from the server 200 for faster displaying. Additionally, in embodiments describing functions as being performed by LCMP 400, the functions can be performed by the server 200, the client 300, the PD 410 or a combination thereof.

FIG. 6 illustrates an initial page (landing page) displayed by client device 300 according to embodiments of the present disclosure. The embodiment of the landing page 600 shown in FIG. 6 is for illustration only. Other embodiments could be used without departing from the scope of the present disclosure.

As indicated previously, it is common for licensed professionals to be legally required to maintain their credentials, as evidenced by the requirement for the practitioners to take continuing education courses in order to maintain their skillsets within their profession. Management of renewal requirements of multiple credentials is complicated because each credential has its own validation timeframe, with specific expiration dates. The risk associated with providing the professional service associated with a lapsed credential is significant. In addition, professionals who own their practice also have the legal responsibility to ensure the validity of their employee's credentials.

The Landing Page 600 of the LCMP 400 communicates the benefits to Business managers and practitioners for using the LCMP 400 to help them manage practitioner credentials. The client device 300 can include an APP that loads the interface in local operation or the interface can be loaded in connection with the client device 300 connecting to the server 200 via the Internet. For the purpose of illustration, the client device 300 is depicted as connecting to the server 200; however, embodiments in which the client device 300 connects to the CA 510, CEP 515 or Insurance Company 520 are also included. The landing page 600 includes a logo 605, an advertisement area 610, a login button 615, a media area 620, a message area 625 and a register button 630.

The logo 605 provides a visual indication, to a user that the APP is by a specific source provider of the LCMP 400 as indicated by a trademark or a brand. The logo 605 can be visual only or include a visual and audio component. In certain embodiments, the logo 605 is hyperlinked such that, in response to a selection on the logo 605, the user is directed to a website of the provider of the LCMP 400. Although the example shown in FIG. 6 illustrates the logo 605 in the upper left area of the landing page 600, the logo 605 could be located in any suitable location.

The advertisement area 610 provides messages regarding additional products or services available to the user from the LCMP 400 provider or a third party provider. The messages regarding additional products or services can be identified as being products or services that are most likely of interest to a user or prospective user of the LCMP 400. In certain embodiments, the advertisement area 610 is hyperlinked such that, in response to a selection on the advertisement area 610, the user is directed to a website of the provider of the product or service indicted in the advertisement message. In certain embodiments, the advertisement message varies over time or changes each time the APP is opened or updated or each time the APP loads a new page. Therefore, the advertisement area 610 can display multiple different advertisement messages at different time intervals. Although the example shown in FIG. 6 illustrates the advertisement area 610 in a top area of the landing page 600, the advertisement area 610 could be located in any suitable location.

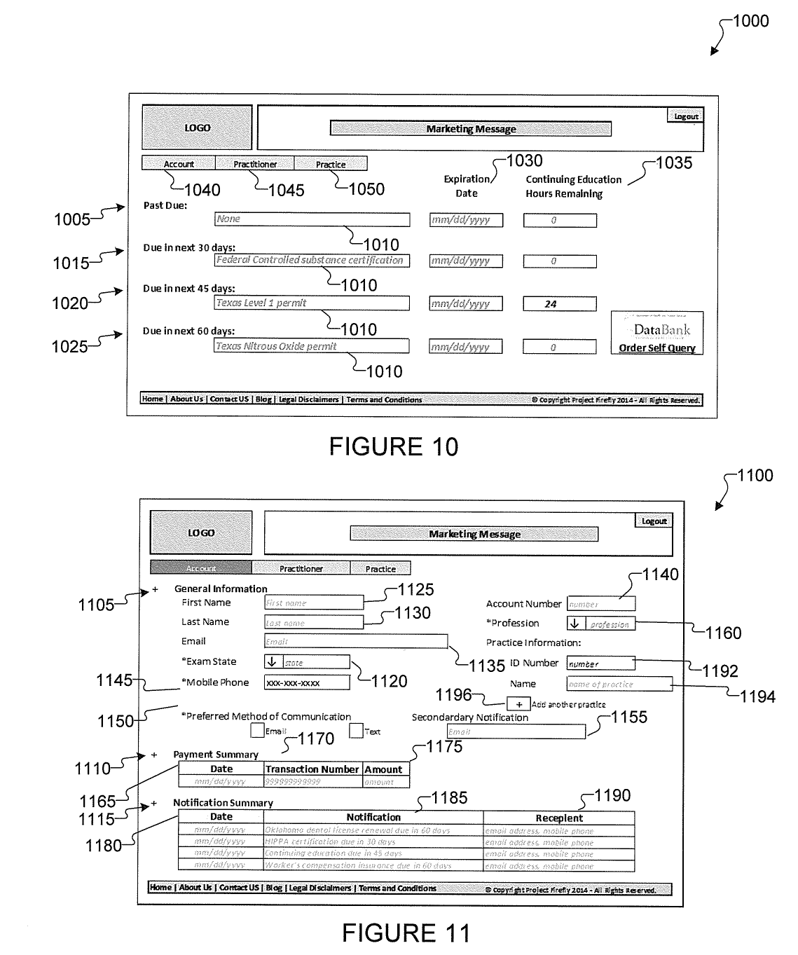

The login button 615 provides access to the LCMP 400 features as discussed herein below with respect to FIG. 10. Although the example shown in FIG. 6 illustrates the login button 615 in an upper right area of the landing page 600, the login button 615 could be located in any suitable location.

The media area 620 provides an audio, video, or both, message to the user regarding the LCMP 400 or client testimonials. The message area 625 provides informational messages to the user regarding the LCMP 400 or additional client testimonials. Although the example shown in FIG. 6 illustrates the media area 620 and message area 625 in a center area of the landing page 600, the media area 620 and message area 625 could be located in any suitable location.

The register button 630 provides a means for a new user to initially access the LCMP 400. Interested business managers or practitioners select, that is, “click”, the register button 630 to access Registration Page to initiate a registration process.

FIG. 7 illustrates a Registration Page displayed by client device 300 according to embodiments of the present disclosure. The embodiment of the Registration Page 700 shown in FIG. 7 is for illustration only. Other embodiments could be used without departing from the scope of the present disclosure.

To initiate the Registration process, the practitioner is required to enter basic information including name and email address. An indicator 705, such as “k”, signifies information must be entered in the associated field. Once information is entered, the practitioner can proceed to a payment page by selecting a Proceed to Payment button 710.

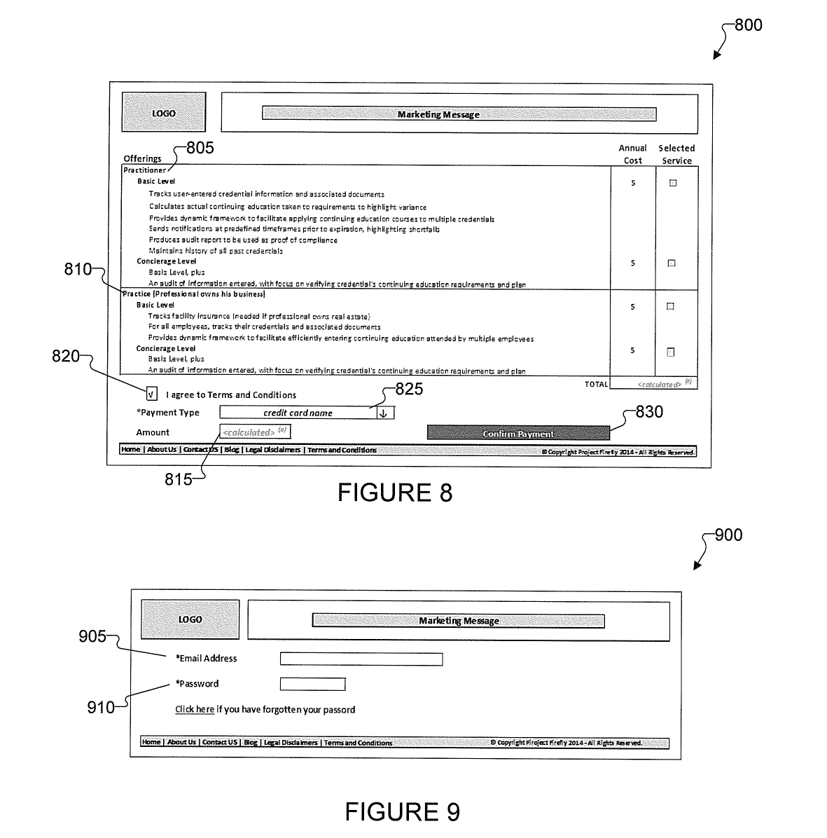

FIG. 8 illustrates a Payment Page displayed by client device 300 according to embodiments of the present disclosure. The embodiment of the Payment Page 800 shown in FIG. 8 is for illustration only. Other embodiments could be used without departing from the scope of the present disclosure.

In certain embodiments, the LCMP 400 includes multiple levels of service structured to suit different needs of the practitioner and business manager. The Payment Page 800 displays multiple levels of service so the practitioner can select the one that best meets their needs. These offerings are based on services focused on helping the practitioner manage their personal credentials, and if they own their business, or are a business manager, with additional services supporting the management of real estate insurance and their employee's professional credentials. The Payment Page 800 demonstrates some of the various offerings to the professional. Based on the “Practitioner” level 805 and “Practice” level 810 of service selected, the associated total amount is calculated and appears in the “Amount” data field 815. In certain embodiments, on the Payment Page 800, data presented in a grey colored box is display only and may not be overwritten by the user.

In certain embodiments, the practitioner is required to agree to a “Terms and Conditions” 820 as a prerequisite to creating an account and becoming a registered user of the LCMP 400. Once the professional enters payment information 825, then they can click the “Confirm Payment” button 830. Once payment is confirmed, the LCMP 400 creates an account in the database with a unique LCMP 400 generated account number associated with the name and email address provided by the practitioner or business manager. In certain embodiments, the LCMP 400 generates, either on its own or in conjunction with the user, an LCMP user ID to access the LCMP 400. To provide a secured method of providing initial access credential, the server 200 sends an email to the email address provided with a time-sensitive password. The practitioner or business manager uses the generated password to initially access their account, at which time the practitioner or business manager is required to enter another password in compliance with commercially accepted security strength guidelines.

FIG. 9 illustrates a Login Page displayed by client device 300 according to embodiments of the present disclosure. The embodiment of the Login Page 900 shown in FIG. 9 is for illustration only. Other embodiments could be used without departing from the scope of the present disclosure.

Registered professionals access their account by entering their access credentials. The access credentials can be a combination of an email address 905 and password 910 or a LCMP user ID and password, biometric, such as a fingerprint, or any suitable means of providing secure login. In the event that the user forgets their password, an option is provided to reset the password and a new Platform generated time-sensitive password, that is a time-sensitive password generated by the LCMP 400, such as server 200, is sent to their email address. The practitioner repeats the actions performed when their account was initially setup.

FIG. 10 illustrates a Dashboard Page displayed by client device 300 according to embodiments of the present disclosure. The embodiment of the Dashboard Page 1000 shown in FIG. 10 is for illustration only. Other embodiments could be used without departing from the scope of the present disclosure.

Once the practitioner successfully logs into the LCMP 400, the client device 300 displays the Dashboard Page 1000. The Dashboard Page 1000 provides a view of a summary of credentials with past due or upcoming expiration dates, along with the number of continuing education hours still required to successfully meet the credential's renewal requirements. For example, the Dashboard Page 1000 displays a past due 1005 section including a license/certification field 1010 that indicates a corresponding license that is past due. The Dashboard Page 1000 also displays sections for additional threshold periods. For example, in the example shown in FIG. 10, the Dashboard Page 1000 displays sections for license requirements due in the next thirty days 1015, license requirements due in the next forty-five days 1020, and license requirements due in the next sixty days 1025. For each section, the Dashboard Page 1000 also indicates a license/certification field 1010, an expiration date 1030, which is the date the respective license requirement expired or will expire, and a number of continuing education hours 1035 remaining to be completed, that have been completed, or both, for this license. The Dashboard Page 1000 presents an at-a-glance view of the practitioner's credential status. The Dashboard Page 1000 also includes “tabs” associated with the services associated with selections made when the user established their account, such as tabs for Account 1040, Practitioner 1045 and Practice 1050. All users are presented with the Account 1040 tab, and the LCMP 400 conditionally presents the Practitioner 1045 and Practice 1050 tabs. In certain embodiments, the LCMP 400 includes links to other websites of interest or websites that are most commonly used by the public to view the status of the practitioner so that the user is able to obtain insight into issues that require the user's attention.

FIG. 11 illustrates an Account Page displayed by client device 300 according to embodiments of the present disclosure. The embodiment of the Account Page 1100 shown in FIG. 11 is for illustration only. Other embodiments could be used without departing from the scope of the present disclosure.

Selecting the Account 1040 on the Dashboard Page 1000 causes the client device 300 to display the Account Page 1100, which presents the user with their account information. The Account Page 1100 presents information related to categories such as General Information 1105, Payment Summary 1110 and Notification Summary 1115. Selecting, such as by a data click or touch, on the symbol next to each category name allows the professional to expand (+) or collapse (−) their view into the information associated with the respective category.

The General Information 1105 category displays information gathered when the account was established along with the unique Platform generated account number, that is a unique account number generated by the LCMP 400, such as by server 200. When the user selected a “Practitioner” level 805 service, as discussed herein above with respect to FIG. 8, the LCMP 400 requires the user to enter the state 1120 in which the practitioner passed the respective board exam to assist in a validation features and provides them the ability to share their credential status with a Practice. The information displayed in the General Information 1105 includes user contact information, such as first name 1125, last name 1130, e-mail 1135, account number 1140, mobile phone number 1145 and a preferred method of communication 1150, if previously entered. The mobile phone number 1145 and a preferred method of communication 1150 can be required to be entered, if not previously entered, to enable the LCMP 400 to automatically generate and distribute electronic notifications based on predefined triggers, such as a number of days prior to credential expiration. In certain embodiments, the user provides a secondary contact 1155, such as contact information for an assistant, so notifications are sent to multiple recipients. In certain embodiments, the user can enter a profession 1160, such as doctor, dentist, lawyer, engineer, accountant, nurse, and so forth. In certain embodiments, in response to the user entering a profession 1160, the LCMP 400 dynamically displays the appropriate credential names 1214 in the drop down selection.

The Payment Summary 1110 category includes payment transaction history for transparency into the agreed upon charges for the service level selected for the account. The transaction history includes data such as date of payment 1165, method of payment, transaction number 1170 and the amount 1175.

The Notification Summary 1115 category displays a history of all notifications automatically sent by the server 200 to the contacts specified by the user for all credentials managed by the LCMP 400. The transaction history includes data such as date of notification 1180, notification sent 1185 and the recipient 1190. In certain embodiments, the recipient 1190 also indicates the method of communication used to send the notification, such as text message using a mobile phone number or e-mail using an e-mail address, or via a social media communication, a telephonic communication, a paper communication, or a combination thereof.

When the user is associated with multiple practice groups, the user can associate his or her account with the multiple practice groups. In certain embodiments, the user enters a Practice ID number 1192 is associated with a group of practitioners. In response to the user entering the Practice ID number 1192, a Practice name 1194 is displayed. In certain embodiments, the user enters a Practice name 1194 associated with a group of practitioners and, in response, one or more Practice ID numbers 1192 is displayed. Thereafter, the information entered into the account by the user is also associated with an account for the entered Practice ID number 1192. By associating his or her information with a Practice ID number 1192, the user authorizes the LCMP 400 to share the user's information with the account associated with the Practice ID number 1192. The user is able to associate his or her information with multiple Practices by selecting an option to “add another practice” 1196.

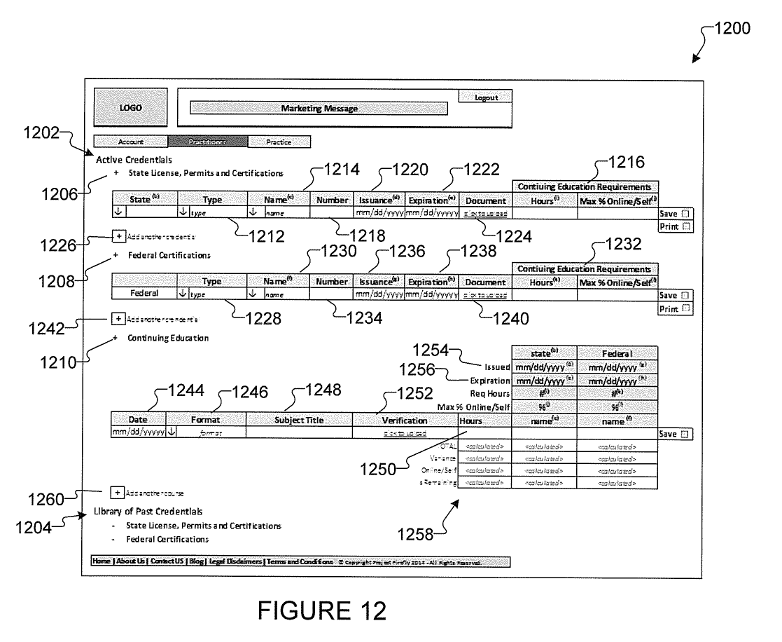

FIG. 12 illustrates a Practitioner Page displayed by client device 300 according to embodiments of the present disclosure. The embodiment of the Practitioner Page 1200 shown in FIG. 12 is for illustration only. Other embodiments could be used without departing from the scope of the present disclosure.

Selecting the Practitioner 1045 on the Dashboard Page 1000 causes the client device 300 to display the Practitioner Page 1200, which presents the user with practitioner information for “active credentials” 1202 as well as prior renewal information associated with credentials in “Library of Past Credentials” 1204. The separation of the active credentials 1202 and Library of Past Credentials 1204 provides focus on renewal status for credentials during their validation period defined from “Issuance date” to “Expiration date”. The LCMP 400 automatically, that is, without addition user input, reminds or notifies the user when a professional credential has lapsed in response to current date being one calendar day past the “Expiration date”. At that time, the user is provided an opportunity to ensure all relevant continuing education data has been recorded before this information is memorialized and moved by the LCMP 400, that is either the server 200 or client device 300 or both, to “Library of Past Credentials” 1204. In the example shown in FIG. 12, the Active Credentials 1202 area is expanded while the Library of Past Credentials 1204 is collapsed. However, such illustration is for example and ease of explanation purposes only.

The Active Credentials 1202 area is organized into multiple categories, such as State License, Permits and Certifications 1206, Federal Certifications 1208, and Continuing Education 1210. Clicking on the symbol next to each category name allows the user to expand (+) or collapse (−) the view into the information associated with that category. The Practitioner Page 1200 dynamically displays and utilizes the information entered into the State License, Permits and Certifications 1206 and Federal Certifications 1208 categories to generate columns in the Continuing Education 1210 category, which provides a framework that ensures alignment of credential and renewal information and facilitates distribution of continuing education hours to all relevant credentials. That is, the LCMP 400, via the client device 300 or server 200, uses information entered into the State License, Permits and Certifications 1206 and Federal Certifications 1208, associated with compliance requirements stored in server 200 or received from CA 510, to create respective columns in the Continuing Education 1210 category.

In certain embodiments, the user enters Active Credentials information for a respective State License, Permits and Certifications 1206 by selecting a drop down arrow and selecting the state, type of credential 1212 (such as, License, Permit, Certificate) and, based on Profession 1160 selected, appropriate Name 1214 (for example, Licensed Dentist, Nitrous Oxide, Controlled Substance) is displayed by selecting a drop down arrow. In certain embodiments, the options listed in the Name 1214 drop down include an “other” selection in case the practitioner has a credential not explicitly listed. The server 200, client device 300, or both, create a data table that specifies the continuing education requirements 1216 that include a number of hours and format of class for the most common unique combinations of state, type of credential and name of credential that is used to automatically present information in data fields for “Hours” and “Max % Online/Self”, which is a maximum amount that the user may complete via online study or self-study. In certain embodiments, the LCMP 400 enables the professional to revise this information in a manner consistent with the agreed Terms and Conditions. The user enters all key information associated with the credential, which includes information such as Number 1218 (for example, license number), Issuance Date 1220, and Expiration Date 1222 and then uploads, via the client device 300, an electronic version of the evidence, such as a copy of the license or document 1224. The user the saves the information, such as by selecting a “save” button, and initiates Platform validation processes that can include notification regarding exam state credentials that have not been entered. Once credential information is successfully saved, the server 200 automatically generates a column for capturing associated continuing education information, which ensures alignment between credential and renewal information. In certain embodiments, the “Active Credentials” information for the State License, Permits and Certifications 1206 includes “State” footnote (b), “Name” footnote (c), “Issuance” footnote (d), “Expiration” footnote (e), “Hours” footnote (i) and “Max % Online/Self” footnote (j). To accommodate entering multiple “State License, Permits and Certifications”, the user can select “Add another credential” 1226 at which time the LCMP 400 automatically creates another row.

The user is also able to enter Active Credentials information for Federal Certifications 1208 by selecting a drop down arrow and selecting type 1228 of credential (for example, a License, Permit, Certificate), and, based on Profession 1160, appropriate Name 1230 (for example Controlled Substance) is displayed by selecting a drop down arrow. In certain embodiments, the options listed in the Name 1230 drop down include an “other” selection in case the practitioner has a credential not explicitly listed. The server 200, client device 300, or both, create a data table that specifies the continuing education requirements 1232 that include a number of hours and format of class for the most common unique combinations of state, type of credential and name of credential that is used to automatically present information in data fields for “Hours” and “Max % Online/Self”, which is a maximum amount that the user may complete via online study or self-study. In certain embodiments, the LCMP 400 enables the professional to revise this information in a manner consistent with the agreed Terms and Conditions. The user enters all key information associated with the credential, which includes information such as Number 1234 (for example, license number), Issuance Date 1236, and Expiration Date 1238 and then uploads, via the client device 300, an electronic version of the evidence, such as a copy of the license or document 1240. The user the saves the information, such as by selecting a “save” button, and initiates Platform validation processes that can include notification regarding exam state credentials that have not been entered. Once credential information is successfully saved, the server 200 automatically generates a column for capturing associated continuing education information, which ensures alignment between credential and renewal information. In certain embodiments, the Active Credentials information for the Federal Certifications 1208 includes “Name” footnote (f), “Issuance” footnote (g), “Expiration” footnote (h), “Hours” footnote (k) and “Max % Online/Self” footnote (1). To accommodate entering multiple “Federal Certifications”, the user can select “Add another credential” 1242 at which time the LCMP 400 automatically creates another row.

The user is also able to enter Active Credentials information for their Continuing Education 1210 by entering information that includes Date 1244 of the first day of the course or the date the course was completed, Format 1246 (For example, Classroom, Online), Subject Title 1248 and Hours 1250 and then uploads, via the client device 300, an electronic version of the proof of certification documents 1252, namely a Verification, such as a Certificate of Completion. Because a continuing education course may be relevant to multiple active credentials, in certain embodiments, the server 200 applies the hours to each applicable credential column in the State License, Permits and Certifications 1206 and the Federal Certifications 1208. In certain embodiments, the client device 300 automatically, or in response to user direction or selection, applies the hours to each applicable credential column in the State License, Permits and Certifications 1206 and the Federal Certifications 1208. That is, upon entering information for a completed course, the LCMP 400 can identify multiple certifications to which the course applies and associate the completed course to each of those identified multiple certifications. The user the saves the information, such as by selecting a “save” button, and initiates Platform validation processes that can include comparing the “Date” 1244 to a timeframe of the credential's defined by the Issued dates 1254 and Expiration dates 1256. Once continuing education information is successfully saved, the server 200 automatically updates calculated values that show the user a compliance status for each credential. Compliance statistics 1258 can include comparing the total continuing education hours taken to the number required and the percent of continuing education hours taken as an “Online/Self” format based on total hours taken and compared to the “Max % Online/Self” percentage. To accommodate entering multiple “Continuing Education” courses, the user can select “Add another course” 1260, at which time the LCMP 400, namely either the client device 300 or the server 200, automatically creates another row.

When a current date is within predefined days prior to “Expiration” date, the server 200 automatically notifies the user using their preferred method of communication as entered in their Account Page 1100, adds it to the Dashboard Page 1000 and logs it in the Notification Summary 1115. In certain embodiments, when the current date is within predefined days prior to “Expiration” date, the client device 300 notifies the user, such as via an alarm or display message. A final notification is sent to the user when current date is one calendar day past “Expiration date”. At that time, the user is provided an opportunity to ensure all relevant continuing education data has been recorded before this information is memorialized and moved by the server to the Library of Past Credentials 1204.

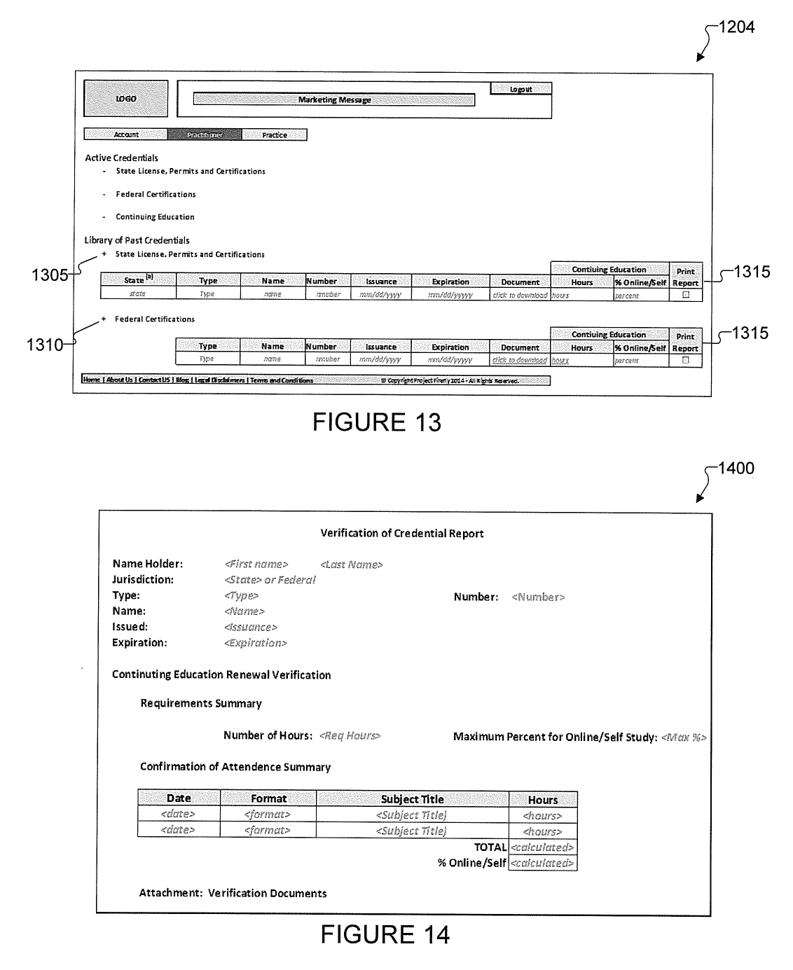

FIG. 13 illustrates a Library of Past Credentials view displayed by client device 300 according to embodiments of the present disclosure. The embodiment of the Library of Past Credentials 1204 shown in FIG. 13 is for illustration only. Other embodiments could be used without departing from the scope of the present disclosure.

The Library of Past Credentials 1204 is organized into multiple categories, such as State License, Permits and Certifications 1305 and Federal Certifications 1310. Selecting the symbol next to each category name allows the user to expand (+) or collapse (−) their view into the information associated with that category. At any time, the user can select “Print Report” 1315 to create a report that includes all or a portion of the information managed by the server 200. The report can be generated and printed in a format that can be provided to the CA 510, namely, the certifying entity, as evidence of renewal compliance. At the time the user requests the report, the LCMP 400 provides the user an option to include an attachment with all or a portion of the verification documents that were uploaded. If the user elects to include verification documents, the server 200 consolidates the separate electronic files into a single electronic file and combines single electronic file with the report. After generating the report, the server 200 transmits the report, and the associated single electronic file if attached, to the client device 300. In certain embodiments, the user can instruct the server 200 to transmit the report, and the associated single electronic file if attached, to the CA 510.

FIG. 14 illustrates a Credential Report according to embodiments of the present disclosure. The embodiment of the Credential Report 1400 shown in FIG. 14 is for illustration only. Other embodiments could be used without departing from the scope of the present disclosure.

In response to a user request, the server 200 generates Credential Report 1400. The Credential Report 1400 includes all or a portion of the information managed by the server 200. The server 200 generates the Credential Report 1400 in a format that can be provided to the CA 510, namely, the certifying entity, as evidence of renewal compliance. In certain embodiments, in response to a request by the user, the server 200 includes an attachment with all or a portion of the verification documents that were uploaded by the user, such as via the client device 300. The server 200 is able to consolidate separate electronic files into a single electronic file and combine the single electronic file with the Credential Report 1400. After generating the Credential Report 1400, the server 200 transmits the Credential Report 1400, and the associated single electronic file if attached, to the client device 300. In certain embodiments, with prior authorization from the user or in response to a request by the user, the server 200 transmits the Credential Report 1400, and the associated single electronic file if attached, to the CA 510.

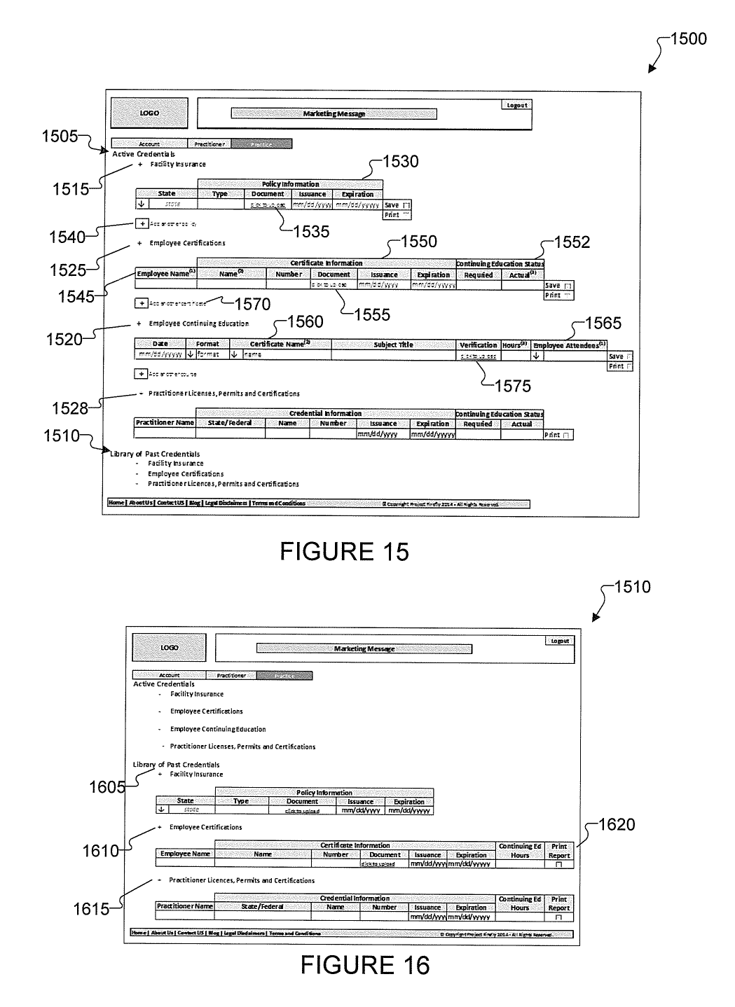

FIG. 15 illustrates a Practice Page displayed by client device 300 according to embodiments of the present disclosure. The embodiment of the Practice Page 1500 shown in FIG. 15 is for illustration only. Other embodiments could be used without departing from the scope of the present disclosure.

In certain embodiments, the user may be a business manager of a practice or an owner of a practice or business. For example, the user can be a hospital administrator, a human resources manager, or supervisor, for a doctor's practice, an engineering firm, an architecture firm, a veterinarian's office, an account firm, or the like. The user may also be an individual that owns a services practice, such as a dentist that owns their own dental practice, a medical doctor that owns his own medical practice or an engineer that owns his own engineering firm. Selecting the Practice 1050 on the Dashboard Page 1000 causes the PD 410 to display the Practice Page 1500, which presents the user with compliance information for a number of practitioners or insurance and compliance documents related to running a service oriented business. It is noted that, in certain embodiments, the user accesses the Practice Page 1500 via the client device 300, which is coupled to the PD 410. In the example shown in FIG. 15, the Practice Page 1500 includes information for active credentials 1505 as well as prior renewal information associated with certificates in Library of Past Credentials 1510. The separation of the active credentials 1505 and Library of Past Credentials 1510 provides focus on renewal status for credentials during their validation period defined from “Issuance date” to “Expiration date”. The LCMP 400 automatically reminds the user that one or more of their employee's credential has lapsed when current date is one calendar day past “Expiration date”. At that time, the user is provided an opportunity to ensure all relevant continuing education data for the employee has been recorded before this information is memorialized and moved by the LCMP 400 to Library of Past Credentials 1510.

The active credentials 1505 area is organized into multiple categories such as Facility Insurance 1515, Employee Continuing Education 1520, Employee Certifications 1525 and Practitioner Licenses, Permits and Certifications 1528. The Facility Insurance 1515 can include information for mal-practice insurance, Workers Compensation insurance, real-property liability insurance, and the like. Selecting the symbol next to each category name allows the professional to expand (+) or collapse (−) their view into the information associated with that category. The LCMP 400 dynamically creates the Practice Page 1500 to dynamically display an Employee Attendees drop down list located in the Employee Continuing Education 1520 category for a particular Certificate based on the Employee Name entered in the Employee Certifications 1525 category to ensure alignment of employees with certificates and those attending continuing education courses. In the example shown in FIG. 15, the Active Credentials 1505 area is expanded while the Library of Past Credentials 1510 is collapsed. However, such illustration is for example and ease of explanation purposes only.

The user is also able to enter Active Credentials information, such as policy information 1530 for their Facility Insurance 1515 by selecting a drop down arrow and selecting the “State” and entering information such as “Type” of policy, “Issuance” date and “Expiration” date and then then uploads, via the PD 410, an electronic version of the evidence 1535, such as a scanned copy of the Insurance Certificate. To accommodate entering multiple “Facility Insurance” policies, the user can select “Add another policy” 1540 at which time the LCMP 400 automatically creates another row.

The user is also able to enter Active Credentials information for their Employee Certifications 1525 by entering information that includes Employee Name 1545 and Certificate Information 1550 such as “Name”, “Number”, “Issuance” date, and “Expiration” date. A Continuing Education Status 1552 that includes “Continuing Education Hours Required” and “Continuing Education Hours Completed” also is displayed. The server 200, the client device 300, or the practice device 410 calculate all or portions of the Continuing Education Status 1552 as a function of the total CE hours taken for a respective credential. The user also can upload an electronic version of the evidence 1555, such as proof of completion of one or more courses. The user then saves the information, such as by selecting a “save” button, and initiates Platform validation processes that can include comparing “Expiration” date to “Issuance” date. Once certificate information is successfully saved, the server 200 automatically adds an “Employee/Certificate Name” combination to the drop down lists for Certificate Name 1560 and Employee Attendees 1565 in the Employee Continuing Education 1520 category and ensures alignment between employees with certificates and those attending relevant continuing education courses. In certain embodiments, the Active Credentials information for the Employee Certifications 1525 and Employee Continuing Education 1520 categories include “Employee Name” footnote (1) and “Certificate Name” footnote (2). To accommodate entering multiple “Employee Certifications”, the user can select “Add another certificate” 1570, at which time the LCMP 400 automatically creates another row.

Once “Employee Certifications” 1525 are entered, continuing education can be entered and associated with employees. The user enters data associated with a continuing education class that can include “Date” of the first day of the course or the date the course was completed, “Subject Title” and “Hours” and clicks on the drop down to select appropriate “Format”. The user also selects drop down associated with “Certificate Name” 1560 to view a list automatically created by the LCMP 400 based on the certificates entered in the Employee Certifications 1525 category and selects the applicable “Name”. The user selects a drop down associated with the data field Employee Attendees 1565 to view the list automatically created by the LCMP 400 based on only those employees who have a need to maintain the associated certificate name, selects the employees who attended the continuing education course, and then uploads, via the client device 300, proof of completion documents or verification 1575, such as, a Course attendee list. Once the professional deems the information entered as complete, they click the “save” button which then initiates Platform validation processes that may include identifying employees who have a certificate and did not attend the course that may be required for their renewal compliance. Once continuing education information is successfully saved, the server 200 automatically updates calculated values for each Employee/Certificate managed, the hours from all continuing education courses taken during the employee's certificate's validation timeframe, as defined as the interval between the “Issuance” date and “Expiration” date so the user can compare it to their required number of hours.

The PD 410 displays “Practitioner Licenses, Permits and Certifications” 1528 associated with the account. That is, the “Practitioner Licenses, Permits and Certifications” 1528 includes the credential status for all Practitioners who have provided the LCMP 400 the permission to share this information under the category with the specified Practice associated with this account. This “Practitioner Licenses, Permits and Certifications” 1528 provides oversight to the status and validation of the multiple practitioners associated with the Practice and assurance, or evidence, that the practitioners associated with the Practice are eligible to provide the service associated with the credential.

When a current date is within predefined days prior to “Expiration” date, the server 200 automatically notifies the user using their preferred method of communication as entered in their Account Page 1100, adds it to the Dashboard Page 1000 and logs it in the Notification Summary 1115. In certain embodiments, when the current date is within predefined days prior to “Expiration” date, the client device 300 notifies the user, such as via an alarm or display message. A final notification is sent to the user when current date is one calendar day past “Expiration date”. At that time, the user is provided an opportunity to ensure all relevant continuing education data has been recorded before this information is memorialized and moved by the Platform to Library of Past Credentials 1510.

FIG. 16 illustrates a Library of Past Credentials view for a Practice displayed by client device 300 according to embodiments of the present disclosure. The embodiment of the Library of Past Credentials 1510 shown in FIG. 16 is for illustration only. Other embodiments could be used without departing from the scope of the present disclosure.

The Library of Past Credentials 1510 is organized into multiple categories such as Facility Insurance 1605, Employee Certifications 1610 and “Practitioner Licenses, Permits and Certifications” 1615. Selecting the symbol next to each category name allows the user to expand (+) or collapse (−) their view into the information associated with that category. At any time, the user can select “Print Report” 1620 to create a report that includes all or a portion of the information managed by the server 200. The report can be generated and printed in a format that can be provided to the CA 510, namely, the certifying entity, as evidence of renewal compliance. At the time the user requests the report, the LCMP 400 provides the user an option to include an attachment with all or a portion of the verification documents that were uploaded. If the user elects to include verification documents, the server 200 consolidates the separate electronic files into a single electronic file and combines single electronic file with the report. After generating the report, the server 200 transmits the report, and the associated single electronic file if attached, to the client device 300 or the PD 410. In certain embodiments, the user can instruct the server 200 to transmit the report, and the associated single electronic file if attached, to the CA 510.

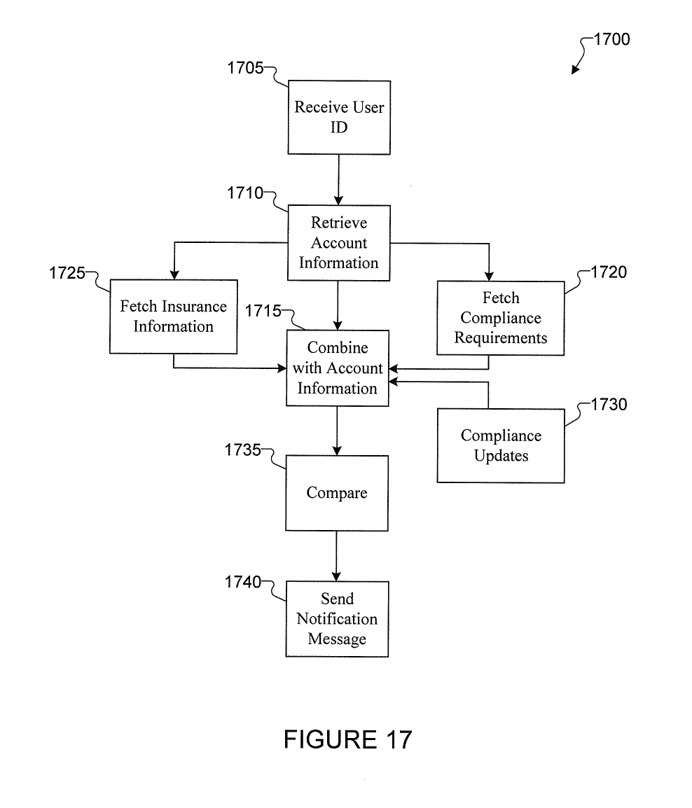

FIG. 17 illustrates a process 1700 for managing credential requirements according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented in processing circuitry in a server or processing circuitry in a client device.

In block 1705, the server 200 receives account identifier information associated with a user account. The user can enter a user ID and password, such as an e-mail address and password. In certain embodiments, the user enters biometric information, such as a fingerprint, as account identifier information.

After receiving the account identifier information, the server 200 retrieves account information, such as from a memory or storage device, associated with the account in block 1710. For example, the server 200 compares the account identifier information with a database of accounts and retrieves the associated account information. The account information may have previously been stored by server 200 or newly inputted by the user, such as via client device 300.

In block 1715, the server combines account information with compliance information, insurance information, or both. For example, the server 200 can fetch compliance requirements from one or more CAs 510 in block 1720 and fetch policy information from one or more Insurance Companies 520 in block 1725. To fetch the compliance requirements in block 1720, the server 200 reviews the licenses or certifications associated with the retrieved account information. The server 200 identifies the compliance authority based on state in which the license was obtained or issued and license or certification information, such as a license type and license number. The server 200 sends the fetch request to the respective CA 510 and, in response, receives the compliance requirements for the license, or certification, from the CA 510. As such, the server 200 retrieves compliance requirements for a specific license or certification based on the licenses, or certifications, in the account information. In certain embodiments, the server 200 receives updates to compliance requirements in block 1730. The compliance requirement updates can be received periodically, in response to a change in law or regulation, in response to operator input, in response to user input, or a combination thereof. In certain embodiments, in response to a change in law or regulation, the server 200 transmits information regarding the change, such as a notification that a change to a specific law has occurred, an HTTP address where information regarding the change can be found, or a summary of the change. In block 1725, the server 200 can receive general policy information or, with authorization from the user, the server 200 can receive specific policy, coverage, or claim information from the Insurance Company 520. The authorization can be received contemporaneously with a request to retrieve account information or at a prior date. In certain embodiments, the server 200 also receives information from one or more CEPs 515, such as course availability information or advertising information for presentation to the user.

In block 1735, the server 200 compares the retrieved account information with information received from the CA 510, the Insurance Company 520, or both. The server 200 identifies whether any requirements are approaching a critical date. The critical date can be a renewal date for a license or certification, an expiration date for a skill, an expiration date for a continuing education course, a requirement date to complete a continuing education course. In certain embodiments, the server 200 calculates the critical date based on compliance information received from the CA 510 and an issuance date of the license or certification or a start or completion date of the continuing education course. The server 200 determines whether a current date is within a threshold period prior to the critical date. The server 200 can apply multiple threshold periods such as, sixty days prior to the critical date, forty-five days prior to the critical date and thirty days prior to the critical date. The server 200 also can determine if the current date matches the critical date or if the current date is past the critical date. For example, the server 200 can identify whether a license or certification requires renewal within a threshold period of time or whether one or more continued education will expire or need to be completed within a threshold period of time. In certain embodiments, the server 200 compares information in the account information with compliance requirements to identify if one or more requirements have not been met or are changed. For example, in response to an update in compliance law received in block 1730, the server 200 can determine whether completed continuing education courses are still valid, and if not, when the completed course will no longer be valid, or when the completed course became invalid. In certain embodiments, the server 200 highlights the changes in requirements to emphasize the changes to the user. The server 200 records an response received from the user in response to the notification of changes in requirements. In certain embodiments, the server 200 also displays information from one or more CEPs 515, such as course availability information or advertising information for presentation to the user.

In block 1740, the server sends one or more notification messages to the user based on communication preferences specified by the user. The notification messages can be sent as a text message to the client device 300, an e-mail to a specified e-mail account, via a social media communication, a telephonic communication, a paper communication, or a combination thereof. The notification messages can be sent to the user, to another individual or entity specified by the user. The notification messages can be formatted differently based on the message. For example, a first message indicating a current date within a first threshold period, such as sixty days prior to the critical date, can be formatted with a first font or color; a second message indicating a current date within a second threshold period, such as forty-five days prior to the critical date, can be formatted with a second font or color; a third message indicating a current date within a third threshold period, such as thirty days prior to the critical date, can be formatted with a third font or color; a fourth message indicating a current date within a fourth threshold period, such as fifteen days prior to the critical date, can be formatted with a fourth font or color; a fifth message indicating a current date matching the critical date, can be formatted with a fifth font or color; and a sixth message indicating a current date past the critical date, can be formatted with a sixth font or color. In certain embodiments, the server 200 includes an audible or visual indicator, such as an audible alarm or a flashing indicator in one or more of the notification messages. The server 200 can send the notification messages automatically or in response to user or operator input.

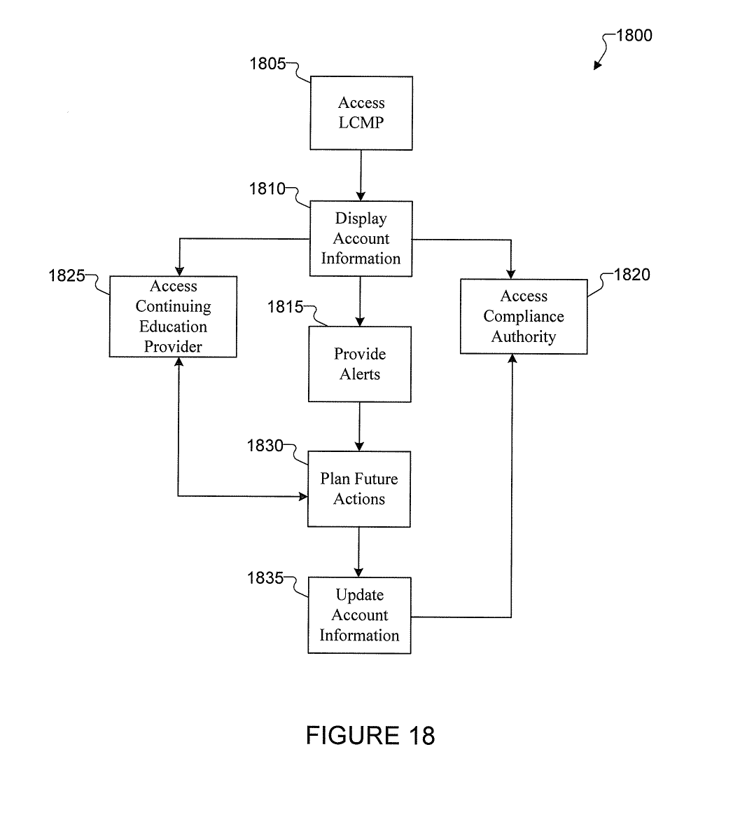

FIG. 18 illustrates a process 1800 for managing credential requirements on a client device according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented in processing circuitry in a client device.

In block 1805, a user, such as a manager or supervisor of multiple practitioners, accesses the LCMP 400. The user can access the LCMP 400 by executing software or an APP on PD 410, accessing a web-portal via the PD 410, activating an APP on the client device 300 coupled to PD 410, accessing a web-portal via the client device 300. Upon executing the APP or accessing the web-portal, the LCMP 400 provides a login and register screen display. In certain embodiments, one or more displays associated with the LCMP 400 can be saved on the client device 300. Additionally, one or more displays can be retrieved from server 200 as needed. The user enters login information into the LCMP 400. The login information can be a user ID and password, such as an e-mail address and password. In certain embodiments, the user enters biometric information, such as a fingerprint, as account identifier information. In certain embodiments, the LCMP 400 remains active after an initial sign-on and is able to provide alert or notifications messages to the user as well as push data to the client device 300 or synchronize data with the client device 300.

In block 1810, the LCMP 400 displays a user home page, or dashboard page, that contains user account information such as a user profile or a summary of credentials. The user account information is stored in server 200. In certain embodiments, all or a portion of the user account information is saved on the client device 300, such as in memory 360. In certain embodiments, all or a portion of the user account information is retrieved from server 200. The account information includes a summary of credentials with past due or upcoming expiration dates, along with the number of continuing education hours still required to successfully meet the credential's renewal requirements. For example, the client device 300 displays a past due section including a license/certification field that indicates a corresponding license that is past due. The client device 300 also displays sections for additional threshold periods. For example, the client device 300 can display sections for license requirements due in the next thirty days, license requirements due in the next forty-five days, and license requirements due in the next sixty days. The client device 300 also indicates, for each section, a license/certification field, an expiration date, which is the date the respective license requirement expired or will expire, and a number of continuing education hours remaining to be completed, that have been completed, or both, for this license. The client device 300 presents an at-a-glance view of the practitioner's credential status. The client device 300 presents “tabs” associated with the services associated with selections made when the user established their account, such as tabs for Account, Practitioner and Practice. All users are presented with the Account tab, and the LCMP 400 conditionally presents the Practitioner and Practice tabs. In certain embodiments, the client device 300 also displays links to other websites of interest or websites that are most commonly used by the public to view the status of the practitioner so that the user is able to obtain insight into issues that require the user's attention.

The account information also includes a listing of Practices to which the user is associated. It is noted that the practitioners, after setting up their account, can be associated with multiple different GIDs. Additionally, the user is able to add additional practice groups to which the user will be associated. The user can associate the additional practice group by entering respective Practice Identifier information, such as a GID for the Practice.

In block 1815, the client device 300 provides alerts to the user. The alerts can indicate that action may be required from the user. In certain embodiments, the client device 300 identifies whether any requirements are approaching a critical date. In certain embodiments, the server 200 identifies whether any requirements are approaching a critical date. The critical date can be a renewal date for a license or certification, an expiration date for a skill, an expiration date for a continuing education course, a requirement date to complete a continuing education course. In certain embodiments, the client device 300, or the server 200, or both calculate the critical date based on compliance information received from the CA 510 and an issuance date of the license or certification or a start or completion date of the continuing education course. The client device 300, or the server 200, or both determine whether a current date is within a threshold period prior to the critical date. Multiple threshold periods can be applied, such as, sixty days prior to the critical date, forty-five days prior to the critical date and thirty days prior to the critical date. A determination is also made as to whether the current date matches the critical date or if the current date is past the critical date. For example, the client device 300 can identify whether a license or certification requires renewal within a threshold period of time or whether one or more continued education will expire or need to be completed within a threshold period of time. The notification messages can be formatted differently based on the message. For example, a first message indicating a current date within a first threshold period, such as sixty days prior to the critical date, can be formatted with a first font or color; a second message indicating a current date within a second threshold period, such as forty-five days prior to the critical date, can be formatted with a second font or color; a third message indicating a current date within a third threshold period, such as thirty days prior to the critical date, can be formatted with a third font or color; a fourth message indicating a current date within a fourth threshold period, such as fifteen days prior to the critical date, can be formatted with a fourth font or color; a fifth message indicating a current date matching the critical date, can be formatted with a fifth font or color; and a sixth message indicating a current date past the critical date, can be formatted with a sixth font or color. In certain embodiments, the client device 300 includes an audible or visual indicator, such as an audible alarm or a flashing indicator in one or more of the notification messages. The client device 300 can display the notification messages automatically or in response to user input.

In certain embodiments, the client device 300 compares information in the account information with compliance requirements to identify if one or more requirements have not been met or are changed. For example, in response to an update in compliance law, the server 200 synchronizes with the client device 300 so that the client device 300 can determine whether completed continuing education courses are still valid, and if not, when the completed course will no longer be valid, or when the completed course became invalid. In certain embodiments, the client device 300 highlights the changes in requirements to emphasize the changes to the user. The client device 300 and the server 200 record a response received from the user in response to the notification of changes in requirements. In certain embodiments, in response to a change in law or regulation, the client device 300 displays information regarding the change, such as a notification that a change to a specific law has occurred, a HTTP address where information regarding the change can be found, or a summary of the change. The user can select the information regarding the change and be directed to the corresponding CA 510 in block 1820. In certain embodiments, the client device 300 also displays information from one or more CEPs 515, such as course availability information or advertising information for presentation to the user. The user can select the information regarding the continuing education and be directed to the corresponding CEP 515 in block 1825. In certain embodiments, the user can select one or more course requirements identified on the dashboard page and, in response to the selection, be provided a listing of course offerings by one or more CEPs 515 that satisfy the course requirement. Thereafter, the user can select, in block 1825, a continuing education course or CEP 515 and be directed to, rerouted to, or otherwise connected with the CEP 515 offering the desired continuing education course.

In block 1830, the user establishes a plan for future action. For example, the user can set a reminder for the LCMP 400, via the client device 300 or the server 200, to remind the user at a specified date or period of time regarding a renewal requirement or regarding a continuing education course or continuing education requirement. The user can also select one or more courses to be taken at a later date. In certain embodiments, in response to the user enrolling in a course via CEP 515 using the client device 300, the LCMP 400 records the enrollment and enters the course in a future planned course section. In certain embodiments, in response to the user selecting a course to be taken in the future, the user is provided a link to connect to one more CEPs 515 that provide the course and which the user can access in block 1825.

In block 1835, the user can update the account information. For example, the user can select an option to pay a renewal fee for a license and be directed to, rerouted to, or otherwise connected with the respective CA 510 to make the payment in block 1820. In certain embodiments, the user can make the payment via the LCMP 400, in which case, in response to the user selecting the option to pay on the client device 300, payment is made to the respective CA 510; proof of payment is stored on the server 200 and, optionally, on the client device 300; and the account information is updated to reflect that the renewal fee has been paid, such as by entering or displaying a new renewal date. In certain embodiments, the user is required to enter the form of payment upon selecting the pay option. In certain embodiments, payment information is stored in the client device 300 or server 200, retrieved and applied upon selecting the pay option. Additionally, upon completing a continuing education course, the user can update the course information and upload proof of completion. In certain embodiments, the proof of completion is received electronically from the CEP 515. In certain embodiments, the client device 300 displays an indicator corresponding to a future planned course upon passing a date at which time the course should have been completed. The user can select the indicator to record that the course was completed and be provided an option to upload the proof of completion. Alternatively, the user can select a second indicator, or another portion of the indicator, to indicate that the course was not taken or completed. In response, the LCMP 400 can remove the course from the future planned list and provide options to relist the course based on input from the user. Additionally, the user is able to add additional practice groups to which the user will be associated. The user can associate the additional practice group by entering respective Practice Identifier information, such as a GID for the Practice.

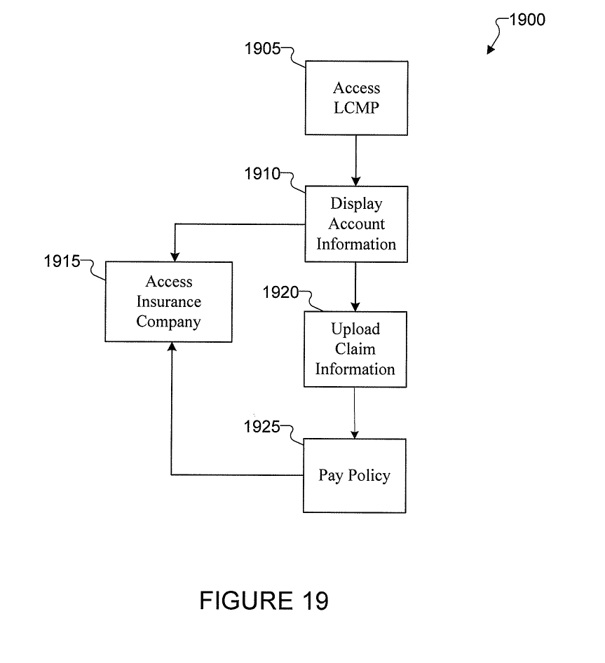

FIG. 19 illustrates a process 1900 for managing insurance requirements on a client device according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented in processing circuitry in a client device.

In block 1905, a user accesses the LCMP 400. The user can access the LCMP 400 by activating an APP on the client device 300 or accessing a web-portal via the client device 300. Upon executing the APP or accessing the web-portal, the LCMP 400 provides a login and register screen display. In certain embodiments, one or more displays associated with the LCMP 400 can be saved on the client device 300. Additionally, one or more displays can be retrieved from server 200 as needed. The user enters login information into the LCMP 400. The login information can be a user ID and password, such as an e-mail address and password. In certain embodiments, the user enters biometric information, such as a fingerprint, as account identifier information. In certain embodiments, the LCMP 400 remains active after an initial sign-on and is able to provide alert or notifications messages to the user as well as push data to the client device 300 or synchronize data with the client device 300.

In block 1910, the LCMP 400 displays a user home page, or dashboard page, that contains user account information such as a user profile or a summary of credentials. The user account information is stored in server 200. In certain embodiments, all or a portion of the user account information is saved on the client device 300, such as in memory 360. In certain embodiments, all or a portion of the user account information is retrieved from server 200. The account information includes insurance information such as liability insurance including malpractice insurance, workers compensation, and personal or real property insurance, and the like. The client device 300 displays policy information for one or more insurance policies. The insurance policy also includes past due or upcoming expiration dates, along with policy coverages. In certain embodiments, the insurance information includes claim information. In certain embodiments, the client device 300 also displays links to one or more Insurance Companies 520 associated with the insurance policies or one or more Insurance Companies 520 that may be of interest to the user. The displayed links, when selected by the user, reroute or connect the client device 300 to the selected Insurance Company 520 to enable the user access the Insurance Company 520 in block 1915 to obtain more information, purchase a policy or submit a claim or question.

In certain embodiments, in block 1920, the user can input claim information. The user can upload relevant documents or evidence to support the claim. In certain embodiments, the user can download claim forms from the server 200 or the Insurance Company in order to file the claim.

In block 1925, the user can make a payment for one or more policies. For example, the server 200 can identify that one or more policies require a payment. The user can select an option to pay the fee for the policy and be directed to, rerouted to, or otherwise connected with the respective Insurance Company 520 to make the payment in block 1920. In certain embodiments, the user can make the payment via the LCMP 400, in which case, in response to the user selecting the option to pay on the client device 300, payment is made to the respective Insurance Company 520; proof of payment is stored on the server 200 and, optionally, on the client device 300. In certain embodiments, the user is required to enter the form of payment upon selecting the pay option. In certain embodiments, payment information is stored in the client device 300 or server 200, retrieved and applied upon selecting the pay option.

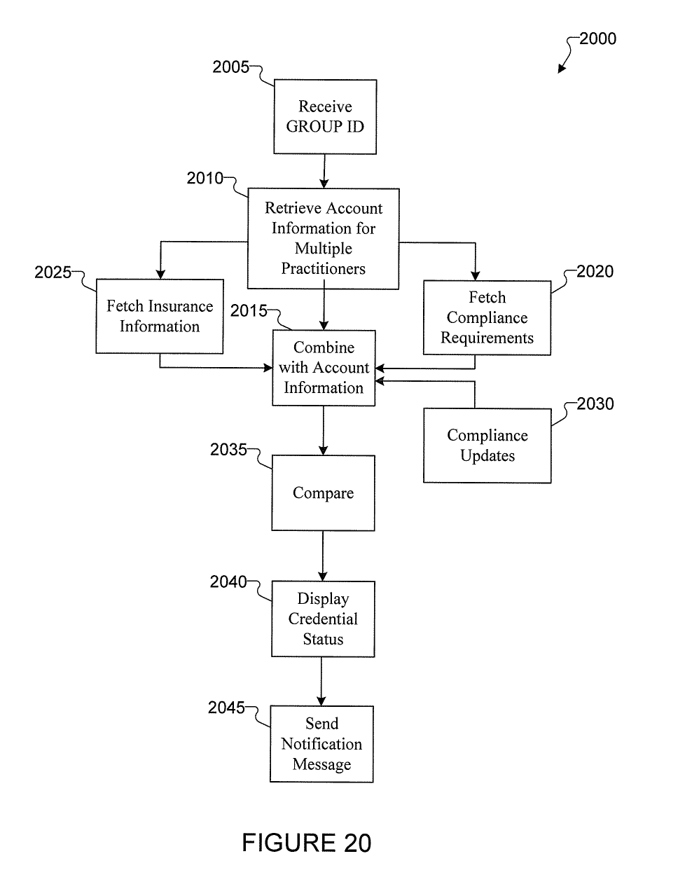

FIG. 20 illustrates a process 2000 for managing credential requirements for a business or practice according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented in processing circuitry in a server or processing circuitry in a client device.

In block 2005, the server 200 receives account identifier information associated with a Practice account. A Practice refers to a business that employs multiple practitioners or a group of practitioners that operate together to share one or more resources. The user, who can be a supervisor or manger of the multiple practitioners or another designated individual of the Practice, can enter a Group ID (GID) and password, such as an e-mail address and password. In certain embodiments, the user enters biometric information, such as a fingerprint, as account identifier information. The GID is associated with a business, a practice, or a group of practitioners. In certain embodiments, the LCMP 400 is able to associate accounts for different practitioners with a same GID. That is, different practitioners can each register, separately, with the LCMP 400 and, after setting up their account, can be subsequently associated with the GID. It is noted that the practitioners, after setting up their account, can be associated with multiple different GIDs. Therefore, any information previously stored for a first practitioner can be easily moved if and when that first practitioner moves to a new practice group or business or becomes associated with the new practice or business. In certain embodiments, the user can enter a first ID, such as a user ID, to access their personal “practitioner” account and enter a second ID, such as a GID, to access account information corresponding to the business, or practice, that the user owns, manages or otherwise supervises.

After receiving the account identifier information, such as a GID, the server 200 retrieves account information, such as from a memory or storage device, associated with the the GID in block 2010. For example, the server 200 compares the account identifier information with a database of accounts and retrieves the account information. The retrieved account information includes names, license or certification information for one or more practitioners associated with the GID. The account information may have previously been stored by server 200 or newly inputted by the user, such as via PD 410.

In block 2015, the server combines account information with compliance information, insurance information, or both. For example, the server 200 can fetch compliance requirements from one or more CAs 510 in block 2020 and fetch policy information from one or more Insurance Companies in block 2025. To fetch the compliance requirements in block 1720, the server 200 reviews the licenses or certifications associated with the practitioners associated with the GID. The server 200 identifies the compliance authority, or compliance authorities, based on state(s) in which the licenses were obtained or issued and license or certification information, such as a license types and license numbers. The server 200 sends the fetch request to the respective CAs 510 and, in response, receives the compliance requirements for the licenses, or certifications, from the CAs 510. As such, the server 200 retrieves compliance requirements for a specific licenses or certifications based on the licenses, or certifications, for all the practitioners associated with the GID. In certain embodiments, the server 200 receives updates to compliance requirements in block 2030. The compliance requirement updates can be received periodically, in response to a change in law or regulation, in response to operator input, in response to user input, or a combination thereof. In certain embodiments, in response to a change in law or regulation, the server 200 transmits information regarding the change, such as a notification that a change to a specific law has occurred, an HTTP address where information regarding the change can be found, or a summary of the change. In block 2025, the server 200 can receive general policy information or, with authorization from the Practice, the server 200 can receive specific policy, coverage, or claim information from one or more Insurance Company 520 for insurance policies related to the Practice or business associated with the GID. The authorization can be received contemporaneously with a request to retrieve account information or at a prior date. In certain embodiments, the server 200 also receives information from one or more CEPs 515, such as course availability information or advertising information for presentation to the user.

In block 2035, the server 200 compares compliance requirements for all the practitioners associated with the GID with information received from the CA 510, the Insurance Company 520, or both. The server 200 identifies whether any requirements are approaching a critical date or have lapsed. The critical date can be a renewal date for a license or certification, an expiration date for a skill, an expiration date for a continuing education course, a requirement date to complete a continuing education course. In certain embodiments, the server 200 calculates the critical date based on compliance information received from the CA 510 and an issuance date of the license or certification or a start or completion date of the continuing education course. The server 200 determines whether a current date is within a threshold period prior to one or more critical dates. The server 200 can apply multiple threshold periods such as, sixty days prior to the critical date, forty-five days prior to the critical date and thirty days prior to the critical date. The server 200 also can determine if the current date matches the critical date or if the current date is past the critical date. For example, the server 200 can identify whether a license or certification requires renewal within a threshold period of time or whether one or more continued education will expire or need to be completed within a threshold period of time. In certain embodiments, the server 200 compares information in the account information with compliance requirements to identify if one or more requirements for one or more practitioners have not been met or are changed. For example, in response to an update in compliance law received in block 2030, the server 200 can determine whether completed continuing education courses are still valid, and if not, when the completed course will no longer be valid, or when the completed course became invalid. In certain embodiments, the server 200 highlights the changes in requirements to emphasize the changes to the user. The server 200 records an response received from the user in response to the notification of changes in requirements. In certain embodiments, the server 200 also displays information from one or more CEPs 515, such as course availability information or advertising information for presentation to the user.

In block 2040, the server 200 generates a display of credential status for each practitioner associated with the GID. In certain embodiments, based on information received from the server 200, the PD 410 displays compliance information that identifies or flags one or more practitioners that are delinquent with regard to the compliance requirements and, as such, enables the user, or Practice officials, to restrict operational activity of flagged practitioners as appropriate.

In block 2045, the server sends one or more notification messages to the user based on communication preferences specified by the user. The notification messages can be sent as a text message to the PD 410, an e-mail to a specified e-mail account, or any suitable form of communication such as, via social media, via telephonic communication and via paper communication. The notification messages can be sent to the user, to another individual or entity specified by the user. The notification messages can be formatted differently based on the message. For example, a first message indicating a current date within a first threshold period, such as sixty days prior to the critical date, can be formatted with a first font or color; a second message indicating a current date within a second threshold period, such as forty-five days prior to the critical date, can be formatted with a second font or color; a third message indicating a current date within a third threshold period, such as thirty days prior to the critical date, can be formatted with a third font or color; a fourth message indicating a current date within a fourth threshold period, such as fifteen days prior to the critical date, can be formatted with a fourth font or color; a fifth message indicating a current date matching the critical date, can be formatted with a fifth font or color; and a sixth message indicating a current date past the critical date, can be formatted with a sixth font or color. In certain embodiments, the server 200 includes an audible or visual indicator, such as an audible alarm or a flashing indicator in one or more of the notification messages. The server 200 can send the notification messages automatically or in response to user or operator input. The notification message identifies the compliance requirement that requires attention and the associated practitioner. In certain embodiments, the server 200 sends multiple messages such that a different message is sent for each practitioner or a different message is sent for each compliance requirement, such as for a specific continuing education requirement. For example, the server 200 can send a notification message indicating that three identified practitioners require the same continuing education course. In certain embodiments, the server 200 sends a single notification message. The message can be sub categorized in which each category is either directed to the requirements for a specific practitioner or a specific compliance requirement.

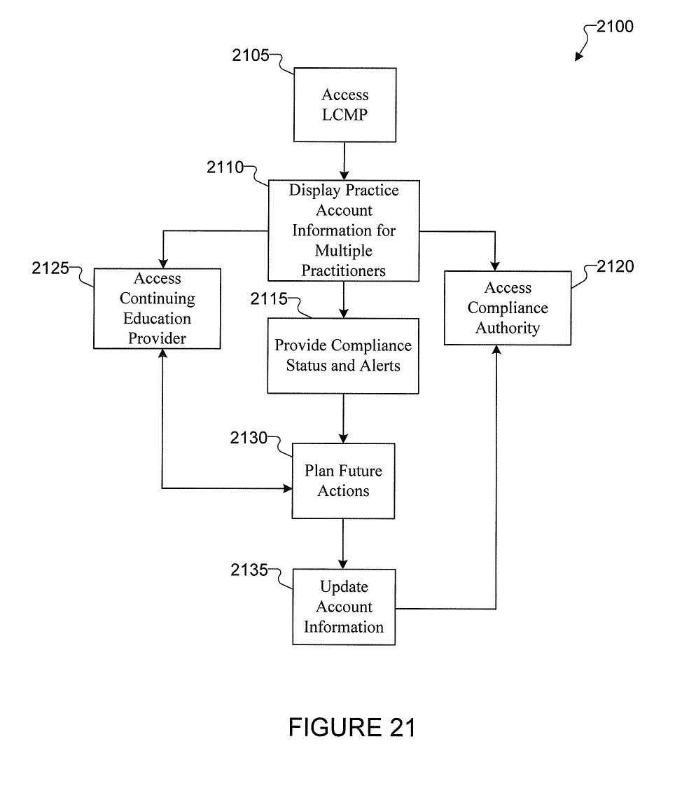

FIG. 21 illustrates a process 2100 for managing credential requirements for a business or practice on a client device according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented in processing circuitry in a client device.

In block 2105, a user accesses the LCMP 400. The user can be a supervisor or manger of the multiple practitioners or another designated individual of the Practice. The user can access the LCMP 400 by executing software or an APP on PD 410, accessing a web-portal via the PD 410, activating an APP on the client device 300 coupled to PD 410, or accessing a web-portal via the client device 300 coupled to PD 410. Upon executing the APP or accessing the web-portal, the LCMP 400 provides a login and register screen display. In certain embodiments, one or more displays associated with the LCMP 400 can be saved on the PD 410. Additionally, one or more displays can be retrieved from server 200 as needed. The user enters login information into the LCMP 400. The login information can be a GID and password. The GID is associated with a Practice. A Practice refers to a business that employs multiple practitioners or a group of practitioners that operate together to share one or more resources. In certain embodiments, the user enters biometric information, such as a fingerprint, as account identifier information. In certain embodiments, the LCMP 400 is able to associate accounts for different practitioners with a same GID. That is, different practitioners can each register, separately, with the LCMP and, after setting up their account, can be subsequently associated with the GID. It is noted that the practitioners, after setting up their account, can be associated with multiple different GIDs. Therefore, any information previously stored for a first practitioner can be easily moved if and when that first practitioner moves to a new practice group or business or associates with the new practice or business. In certain embodiments, the user can enter a first ID, such as a user ID, to access their personal “practitioner” account and enter a second ID, such as a group ID, to access account information corresponding to the business, or practice, that the user owns, manages or otherwise supervises. In certain embodiments, the LCMP 400 remains active after an initial sign-on and is able to provide alert or notifications messages to the user as well as push data to the PD 410 or synchronize data with the PD 410.

In block 2110, the LCMP 400 displays a user home page, or dashboard page, that contains group account information, such as a summary of credentials for all the practitioners associated with the GID. The group account information is stored in server 200. In certain embodiments, all or a portion of the group account information is saved on the PD 410, such as in a memory. In certain embodiments, all or a portion of the group account information is retrieved from server 200. The group account information includes, for each practitioner associated with the GID, a summary of credentials with past due or upcoming expiration dates, along with the number of continuing education hours still required to successfully meet the credential's renewal requirements. For example, the PD 410 displays a past due section including a license/certification field that indicates a practitioners and a corresponding license that is past due. The PD 410 also displays sections for additional threshold periods. For example, the PD 410 can display sections for license requirements due in the next thirty days, license requirements due in the next forty-five days, and license requirements due in the next sixty days. The PD 410 also indicates, for each section, a license/certification field, an expiration date, which is the date the respective license requirement expired or will expire, and a number of continuing education hours remaining to be completed, that have been completed, or both, for this license. The PD 410 presents an at-a-glance view of the credential status for each practitioner's associated with the GID. The PD 410 presents “tabs” associated with the services associated with selections made when the user established their account, such as tabs for Account, Practitioner and Practice. All users are presented with the Account tab, and the LCMP 400 conditionally presents the Practitioner and Practice tabs. In certain embodiments, the PD 410 also displays links to other websites of interest or websites that are most commonly used by the public to view the status of the practitioner so that the user is able to obtain insight into issues that require the user's attention.

In block 2115, the PD 410 provides compliance status and alerts to the user. The compliance status provides information that illustrates whether or not the practitioners associated with the GID have satisfied all license or credential requirements and, as such, are in good standing. The compliance status identifies or flags one or more practitioners that are delinquent with regard to the compliance requirements and, as such, enables the user, or Practice officials, to restrict operational activity of flagged practitioners as appropriate. The alerts can indicate that action may be required from the user. In certain embodiments, the PD 410 identifies whether any requirements are approaching a critical date or have lapsed. In certain embodiments, the server 200 identifies whether any requirements are approaching a critical date. The critical date can be a renewal date for a license or certification, an expiration date for a skill, an expiration date for a continuing education course, a requirement date to complete a continuing education course. In certain embodiments, the PD 410, or the server 200, or both calculate the critical date based on compliance information received from the CA 510 and an issuance date of the license or certification or a start or completion date of the continuing education course. The PD 410, or the server 200, or both determine whether a current date is within a threshold period prior to the critical date. Multiple threshold periods can be applied, such as, sixty days prior to the critical date, forty-five days prior to the critical date and thirty days prior to the critical date. A determination is also made as to whether the current date matches the critical date or if the current date is past the critical date. For example, the PD 410 can identify whether a license or certification requires renewal within a threshold period of time or whether one or more continued education will expire or need to be completed within a threshold period of time. The notification messages can be formatted differently based on the message. For example, a first message indicating a current date within a first threshold period, such as sixty days prior to the critical date, can be formatted with a first font or color; a second message indicating a current date within a second threshold period, such as forty-five days prior to the critical date, can be formatted with a second font or color; a third message indicating a current date within a third threshold period, such as thirty days prior to the critical date, can be formatted with a third font or color; a fourth message indicating a current date within a fourth threshold period, such as fifteen days prior to the critical date, can be formatted with a fourth font or color; a fifth message indicating a current date matching the critical date, can be formatted with a fifth font or color; and a sixth message indicating a current date past the critical date, can be formatted with a sixth font or color. In certain embodiments, the PD 410 includes an audible or visual indicator, such as an audible alarm or a flashing indicator in one or more of the notification messages. The PD 410 can display the notification messages automatically or in response to user input. In certain embodiments, the user can also send the notification messages to the practitioners advising the respective practitioner regarding an upcoming requirement. For example, the PD 410 can send a text message or e-mail message to one or more practitioners advising the respective practitioner regarding an upcoming requirement that a requirement has lapsed, or that one or more operational activities have been, or will be, restricted. In certain embodiments, the user can select the practitioner name and be able to either call the practitioner, or type and send a customized message or e-mail.

In certain embodiments, the PD 410 compares information in the account information with compliance requirements to identify if one or more requirements have not been met or are changed. For example, in response to an update in compliance law, the server 200 synchronizes with the PD 410 so that the PD 410 can determine whether completed continuing education courses are still valid, and if not, when the completed course will no longer be valid, or when the completed course became invalid. In certain embodiments, the PD 410 highlights the changes in requirements to emphasize the changes to the user. The PD 410 and the server 200 record a response received from the user in response to the notification of changes in requirements. In certain embodiments, in response to a change in law or regulation, the PD 410 displays information regarding the change, such as a notification that a change to a specific law has occurred, a HTTP address where information regarding the change can be found, or a summary of the change. The user can select the information regarding the change and be directed to the corresponding CA 510 in block 2120. In certain embodiments, the client device 300 also displays information from one or more CEPs 515, such as course availability information or advertising information for presentation to the user. The user can select the information regarding the continuing education and be directed to the corresponding CEP 515 in block 2125. In certain embodiments, the user can select one or more course requirements identified on the dashboard page and, in response to the selection, be provided a listing of course offerings by one or more CEPs 515 that satisfy the course requirement. Thereafter, the user can select, in block 2125, a continuing education course or CEP 515 and be directed to, rerouted to, or otherwise connected with the CEP 515 offering the desired continuing education course.

In block 2130, the user establishes a plan for future action. For example, the user can set a reminder for the LCMP 400, via the PD 410 or the server 200, to remind the user at a specified date or period of time regarding one or more renewal requirements or regarding a continuing education course or continuing education requirement. The user can also select one or more courses to be taken by specified practitioners at a later date. In certain embodiments, the user can review requests by the practitioners to take one or more courses. The user is able to review course information such as dates of courses, methods of delivery, such as online, self-study or in person attendance, course curriculum and applicability to respective licenses or certifications. The user is able to approve or deny the one or more courses that have been selected, or otherwise requested, by specified practitioners. That is, the user can setup planned curricula for each practitioner associated with the GID. In certain embodiments, in response to the user enrolling a practitioner in a course via CEP 515 using the PD 410, the LCMP 400 records the enrollment, enters the course in a future planned course section and sends a confirmation message to the user, the practitioner, or both. In certain embodiments, in response to the user selecting a course to be taken in the future, the user is provided a link to connect to one more CEPs 515 that provide the course and to which the user can access in block 2125.

In block 2135, the user can update the group account information. For example, the user can select an option to pay a renewal fee for a license and be directed to, rerouted to, or otherwise connected with the respective CA 510 to make the payment in block 2120. In certain embodiments, the user can make the payment via the LCMP 400, in which case, in response to the user selecting the option to pay on the PD 410, payment is made to the respective CA 510; proof of payment is stored on the server 200 and, optionally, on the PD 410; and the account information is updated to reflect that the renewal fee has been paid, such as by entering or displaying a new renewal date. In certain embodiments, the user is required to enter the form of payment upon selecting the pay option. In certain embodiments, payment information is stored in the PD 410 or server 200, retrieved and applied upon selecting the pay option. Additionally, upon completing a continuing education course, the user can update the course information and upload proof of completion. In certain embodiments, the proof of completion is received electronically from the CEP 515. In certain embodiments, the PD 410 displays an indicator corresponding to a future planned course upon passing a date at which time the course should have been completed. The user can select the indicator to record that the course was completed and be provided an option to upload the proof of completion. Alternatively, the user can select a second indicator, or another portion of the indicator, to indicate that the course was not taken or completed. In response, the LCMP 400 can remove the course from the future planned list and provide options to relict the course based on input from the user. In certain embodiments, the user can make the payment via the LCMP 400, in which case, in response to the user selecting the option to pay on the PD 410, payment is made to the respective CEP 515; proof of payment is stored on the server 200 and, optionally, on the PD 410; and the account information is updated to reflect that the continuing education course fee has been paid.

Although various features have been shown in the figures and described above, various changes may be made to the figures. For example, the size, shape, arrangement, and layout of components shown in FIGS. 1 through 16 are for illustration only. Each component could have any suitable size, shape, and dimensions, and multiple components could have any suitable arrangement and layout. Also, various components in FIGS. 1 through 16 could be combined, further subdivided, or omitted and additional components could be added according to particular needs. Further, each component in a device or system could be implemented using any suitable structure(s) for performing the described function(s). In addition, while FIGS. 17 through 21 illustrate various series of steps, various steps in FIGS. 17 through 21 could overlap, occur in parallel, occur multiple times, or occur in a different order.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A server comprising:
a storage device configured to store information related to one or more licenses or credentials;
an interface configured to receive a requirement corresponding with the one or more licenses or credentials;
processing circuitry configured to:
store the requirement with the information related to the one or more licenses or credentials,
analyze the information related to one or more licenses or credentials and determine a critical date associated with the requirement,
determine whether a current date is within a threshold period of time from the critical date, and
in response to determining that the current date is within the threshold period of time, transmit, via the interface, a notification message to a client device, the notification message comprising an alert configured to providing information to the client device regarding an action to be taken.

2. The server as set forth in claim 1, wherein the interface is configured to receive the requirement from the client device or a compliance authority.

3. The server as set forth in claim 1, wherein the interface is configured to receive update information, the update information configured to indicate a change in a law or regulation affecting the one or more licenses or credentials; and
in response to receiving the update information, the processing circuitry is configured to:
store the update information with the information related to the one or more licenses or credentials, and
transmit an update message to the client device, the update message configured to at least one of: provide information regarding the change in a law or regulation; or provide a hypertext transport protocol (HTTP) address corresponding to where details regarding the change in the law or regulation are located.

4. The server as set forth in claim 3, wherein the processing circuitry is further configured to determine whether the requirement has changed in response to the update information; and
when the requirement has changed, the update message further includes an indicator configured to indicate the change to the requirement.

5. The server as set forth in claim 1, wherein the requirement includes a continuing education requirement, and wherein the interface is configured to receive documentation via an electronic communication with the client device, the documentation comprising proof of completion of the continuing education requirement.

6. The server as set forth in claim 5, wherein the processing circuitry is configured to store, in the storage device, the documentation associated with the one or more licenses or credentials.

7. The server as set forth in claim 1, wherein the processing circuitry is configured to generate summary information for display on the client device, the summary information comprising at least one of:
a summary of credentials with past due or upcoming expiration dates,
a number of continuing education hours required to meet a renewal requirement,
a listing of planned continuing education courses,
an address of the compliance authority,
an address of at least one provider of continuing education courses, and
an address of at least one insurance provider.

8. The server as set forth in claim 7, wherein the summary information corresponds with a first license or credential held by a first person and a second license or credential held by a second person.

9. A method comprising:
receiving, by a server, information related to one or more licenses or credentials;
storing, by the server, the information related to one or more licenses in a storage device;
identifying, by the server, at least one requirement corresponding with the one or more licenses or credentials; and
generating display data configured to be displayed on a client device, the display data comprising summary information comprising at least one of:
a summary of credentials with past due or upcoming expiration dates,
a number of continuing education hours required to meet a renewal requirement;
a listing of planned continuing education courses;
an address of the compliance authority;
an address of at least one provider of continuing education courses; and
an address of at least one insurance provider.

10. The method as set forth in claim 9, further comprising:
determining, by the server, a critical date associated with the at least one requirement,
determining, by the server, whether a current date is within a threshold period of time from the critical date, and
in response to determining that the current date is within the threshold period of time, transmitting, by the server, a notification message to the client device, the notification message comprising an alert configured to provide information regarding an action to be taken.

11. The method as set forth in claim 9, wherein receiving the information related to one or more licenses or credentials comprises:
fetching data from at least one of: a compliance authority and an insurance company.

12. The method as set forth in claim 9, further comprising:
receiving update information, the update information configured to indicate a change in a law or regulation affecting the one or more licenses or credentials; and
in response to receiving the update information:
storing the update information with the information related to the one or more licenses or credentials, and
transmitting an update message to the client device, the update message configured to at least one of: provide information regarding the change in a law or regulation; or provide a hypertext transport protocol (HTTP) address corresponding to where details regarding the change in the law or regulation are located.

13. The method as set forth in claim 12, further comprising:
determining whether the requirement has changed in response to the update information; and
when the requirement has changed, including an indicator in the summary information, the indicator configured to indicate the change to the requirement.

14. The method as set forth in claim 9, wherein the at least one requirement includes a continuing education requirement, the method further comprising:
receiving documentation via an electronic communication with the client device, the documentation comprising proof of completion of the continuing education requirement.

15. The method as set forth in claim 14, further comprising storing, by the server, the documentation associated with the one or more licenses or credentials.

16. The method as set forth in claim 9, wherein the summary information corresponds with a first license or credential held by a first person and a second license or credential held by a second person.

17. A client computing device comprising:
a display configured to display information related to one or more licenses or credentials and at least one requirement corresponding to the one or more licenses or credentials;
processing circuitry configured to receive user compliance information to be associated with the one or more licenses or credentials; and
a transmitter configured transmit at least a portion of the user compliance information to a remote server.

18. The client computing device as set forth in claim 17, wherein processing circuitry is configured to at least one of:
determine that a current date is within a threshold period of time from a critical date associated with the requirement; and
receive a first message from the remote server indicating that the current date is within the threshold period of time from the critical date associated with the requirement.

19. The client computing device as set forth in claim 18, wherein processing circuitry is configured to cause the display to at least one of:
indicate that the current date is within the threshold period of time from the critical date associated with the requirement; and
display an alert message configured to provide information regarding an action to be taken.

20. The client computing device as set forth in claim 17, wherein the processing circuitry is configured to receive the requirement from a compliance authority.

21. The client computing device as set forth in claim 17, wherein the processing circuitry is configured to receive update information, the update information configured to indicate a change in a law or regulation affecting the one or more licenses or credentials; and
in response to receiving the update information, the processing circuitry is configured to cause the display to:
display an update indicator configured to at least one of: provide information regarding the change in a law or regulation; or provide a hypertext transport protocol (HTTP) address corresponding to where details regarding the change in the law or regulation are located.

22. The client computing device as set forth in claim 21, wherein the processing circuitry is further configured to determine whether the requirement has changed in response to the update information; and
when the requirement has changed, the update indicator is further configured to indicate the change to the requirement.

23. The client computing device as set forth in claim 17, wherein the requirement includes a continuing education requirement, and wherein the processing circuitry is configured to receive documentation via at least one of: a user interface, an external interface, and a communication with a third party;
wherein the documentation comprises proof of completion of the continuing education requirement.

24. The client computing device as set forth in claim 23, wherein the processing circuitry is configured to at least one of:
store, in a memory, the documentation associated with the one or more licenses or credentials; and
transmit the documentation to the remote server.

25. The client computing device as set forth in claim 17, wherein the processing circuitry is configured to generate summary information for display on the display, the summary information comprising at least one of:
a summary of credentials with past due or upcoming expiration dates,
a number of continuing education hours required to meet a renewal requirement;
a listing of planned continuing education courses;
an address of the compliance authority;
an address of at least one provider of continuing education courses; and
an address of at least one insurance provider.

26. The client computing device as set forth in claim 25, wherein the summary information corresponds with a first license or credential held by a first person and a second license or credential held by a second person.

27. A plurality of instructions stored on a non-transitory computer readable medium, the plurality of instructions configured to, when executed by a processor, cause the processor to:
generate display information related to one or more licenses or credentials and at least one requirement corresponding to the one or more licenses or credentials;
receive user compliance information to be associated with the one or more licenses or credentials; and
transmit at least a portion of the user compliance information to a remote server.

28. The plurality of instructions as set forth in claim 27, wherein the plurality of instructions is further configured to cause the processor to at least one of:
determine that a current date is within a threshold period of time from a critical date associated with the requirement; and
receive a first message from the remote server indicating that the current date is within the threshold period of time from the critical date associated with the requirement.

29. The plurality of instructions as set forth in claim 28, wherein the plurality of instructions is further configured to cause the processor to at least one of:
indicate that the current date is within the threshold period of time from the critical date associated with the requirement; and
generate for display, an alert message configured to provide information regarding an action to be taken.

30. The plurality of instructions as set forth in claim 27, wherein the plurality of instructions is further configured to cause the processor to receive the requirement from a compliance authority.

31. The plurality of instructions as set forth in claim 27, wherein the plurality of instructions is further configured to cause the processor to:
receive update information, the update information configured to indicate a change in a law or regulation affecting the one or more licenses or credentials; and
in response to receiving the update information, generate for display, an update indicator configured to at least one of: provide information regarding the change in a law or regulation; or provide a hypertext transport protocol (HTTP) address corresponding to where details regarding the change in the law or regulation are located.

32. The plurality of instructions as set forth in claim 31, wherein the plurality of instructions is further configured to cause the processor to determine whether the requirement has changed in response to the update information; and
when the requirement has changed, the update indicator is further configured to indicate the change to the requirement.

33. The plurality of instructions as set forth in claim 27, wherein the requirement includes a continuing education requirement, and the plurality of instructions is configured to cause the processor to receive documentation via at least one of: a user interface, an external interface, and a communication with a third party;
wherein the documentation comprises proof of completion of the continuing education requirement.

34. The plurality of instructions as set forth in claim 33, wherein the plurality of instructions is configured to cause the processor to at least one of:
store, in a memory, the documentation associated with the one or more licenses or credentials; and
transmit the documentation to the remote server.

35. The plurality of instructions as set forth in claim 27, wherein the plurality of instructions is configured to cause the processor to generate summary information for display on a display, the summary information comprising at least one of:
a summary of credentials with past due or upcoming expiration dates,
a number of continuing education hours required to meet a renewal requirement;
a listing of planned continuing education courses;
an address of the compliance authority;
an address of at least one provider of continuing education courses; and
an address of at least one insurance provider.

36. The plurality of instructions as set forth in claim 35, wherein the summary information corresponds with a first license or credential held by a first person and a second license or credential held by a second person.
